(19) United States
(12) Patent Application Publication
(10) Pub. No.: US 2026/0228913 A1
(43) Pub. Date: Aug. 6, 2026

(54) OPTICAL AXIS DIRECTION MEASUREMENT SYSTEM, OPTICAL AXIS DIRECTION MEASUREMENT METHOD, PROGRAM, OPTICAL AXIS DIRECTION MEASUREMENT DEVICE, AND ACCEPTANCE DETERMINATION SYSTEM

(71) Applicant: KYOCERA Corporation, Kyoto-shi, Kyoto (JP)

(72) Inventors: Kazuki SHIMOSE, Yasu-shi, Shiga (JP); Tatsuya TAMAMURA, Moriyama-shi, Shiga (JP); Ryo TADAUCHI, Otsu-shi, Shiga (JP); Shoichi TSUBOTA, Omihachiman-shi, Shiga (JP)

(21) Appl. No.: 19/151,953

(22) PCT Filed: Jan. 22, 2024
(86) PCT No.: PCT/JP2024/001723

§ 371 Date: Jul. 29, 2025

(30) Foreign Application Priority Data
Jan. 31, 2023 (JP) 2023-013626
May 23, 2023 (JP) 2023-084985

(51) Int. Cl. G06T 7/73; G06T 7/00; H04N 23/695

(52) U.S. Cl. CPC G06T 7/74; G06T 7/001; H04N 23/695; G06T 2207/30108

(57) ABSTRACT

An optical axis direction measurement system includes an aerial image display device, an imaging device, and a measurer. The aerial image display device forms an aerial image as a real image using image light emitted from at least one image display. The imaging device captures the aerial image. The measurer measures an optical axis direction of the aerial image based on captured images of a plurality of imaging portions in an imaging plane of the aerial image.

### TECHNICAL FIELD

The present disclosure relates to an optical axis direction measurement system, an optical axis direction measurement method, a program, an optical axis direction measurement device, and an acceptance determination system.

### BACKGROUND OF INVENTION

A known aerial image display device is described in, for example, Patent Literature 1.

### CITATION LIST

### Patent Literature

Patent Literature 1: Japanese Unexamined Patent Application Publication No. 2015-191051

### SUMMARY

In an aspect of the present disclosure, an optical axis direction measurement system includes an aerial image display device, an imaging device, and a measurer. The aerial image display device forms an aerial image as a real image using image light emitted from at least one image display. The imaging device captures the aerial image. The measurer measures an optical axis direction of the aerial image based on captured images of a plurality of imaging portions in an imaging plane of the aerial image.

In an aspect of the present disclosure, an optical axis direction measurement method is a method for measuring an optical axis direction of an aerial image formed by an aerial image display device that forms the aerial image as a real image using image light emitted from at least one image display. The optical axis direction measurement method includes capturing the aerial image and calculating a plurality of characteristic values of luminance distribution waveforms of captured images of a plurality of imaging portions of the aerial image, and measuring the optical axis direction of the aerial image based on the plurality of characteristic values.

In an aspect of the present disclosure, a program is executable by an optical axis direction measurement system including an aerial image display device that forms an aerial image as a real image using image light emitted from at least one image display, an imaging device that captures the aerial image, and a measurer. The program causes the optical axis direction measurement system to perform operations including calculating, with the measurer, a plurality of characteristic values of luminance distribution waveforms of captured images of a plurality of imaging portions of the aerial image, and measuring the optical axis direction of the aerial image based on the plurality of characteristic values.

In an aspect of the present disclosure, an acceptance determination system includes the above optical axis direction measurement system and a determiner. The determiner measures a deviation of the optical axis direction of the aerial image measured by the measurer from a predetermined optical axis direction of the aerial image display device, and determines the aerial image display device to be an acceptable product when the deviation is less than or equal to a third predetermined value.

In an aspect of the present disclosure, an optical axis direction measurement device includes an obtainer and a measurer. The obtainer obtains a plurality of captured images of a plurality of imaging portions in an imaging plane of an aerial image. The measurer measures an optical axis direction of the aerial image based on characteristic values of luminance distribution waveforms of the plurality of captured images.

In an aspect of the present disclosure, an optical axis direction measurement device includes an imager and a measurer. The imager captures an aerial image formed as a real image in a space. The measurer measures an optical axis direction of the aerial image based on characteristic values of luminance distribution waveforms of a plurality of captured images calculated as resolutions of the plurality of captured images of a plurality of imaging portions in an imaging plane of the aerial image.

### BRIEF DESCRIPTION OF THE DRAWINGS

The objects, features, and advantages of the present disclosure will become more apparent from the following detailed description and the drawings.

FIG. 1 is a perspective view of an optical axis direction measurement system according to one embodiment of the present disclosure.

FIG. 2 is a cross-sectional view of an aerial image display device included in the optical axis direction measurement system in FIG. 1.

FIG. 3 is a partially enlarged view of an example test pattern for measuring an optical axis direction of an aerial image formed by the aerial image display device.

FIG. 4 is a partially enlarged view of a captured image of a test pattern captured with an imaging device.

FIG. 5 is a partially enlarged view of a captured image of a test pattern captured with the imaging device.

FIG. 6 is a graph of a luminance distribution waveform as a line spread function calculated from the captured image in FIG. 5.

FIG. 7 is a graph of a modulation transfer function (MTF) calculated from the line spread function in FIG. 6.

FIG. 8 is a diagram of another example test pattern for measuring the optical axis direction of an aerial image formed by the aerial image display device.

FIG. 9 is a diagram of a captured image of a test pattern captured with the imaging device.

FIG. 10 is a side view of the imaging device being defocused.

FIG. 11A is a partially enlarged view of an example captured image of a test pattern captured with the imaging device.

FIG. 11B is a partially enlarged view of an example captured image of a test pattern captured with the imaging device.

FIG. 11C is a view of an example captured image of a test pattern captured with the imaging device.

FIG. 12 is a graph showing focus positions each corresponding to an imaging portion.

FIG. 13 is a diagram describing an optical axis deviation corresponding to the graph in FIG. 12.

FIG. 14 is a graph showing focus positions each corresponding to an imaging portion.

FIG. 15 is a diagram describing an optical axis deviation corresponding to the graph in FIG. 14.

FIG. 16 is a diagram describing rotation of the imaging device.

FIG. 17 is a perspective view of an acceptance determination system according to one embodiment of the present disclosure.

FIG. 18 is a flowchart describing an example operation of the acceptance determination system.

FIG. 19 is a flowchart describing another example operation of the acceptance determination system.

FIG. 20 is a graph of a corrected line spread function in a luminance distribution waveform.

FIG. 21 is graph of a corrected line spread function in a luminance distribution waveform.

FIG. 22 is a plan view of main components when a line spread function in a luminance distribution waveform is corrected.

FIG. 23 is a plan view of the main components when a line spread function in a luminance distribution waveform is corrected.

### DESCRIPTION OF EMBODIMENTS

Various aerial image display devices that have been proposed form an aerial image as a real image using image light emitted from a display panel. Patent Literature 1 describes an aerial image display device that adjusts, to cause a user of the aerial image display device to view an appropriate aerial image, a pixel arrangement in a display panel or image signals input into the display panel based on modulation transfer function (MTF) values of imaging elements at a spatial frequency.

A known aerial image display device does not have a structure for measuring an aerial image formed in a space and being accurately oriented in a direction of the user, and controlling an optical axis direction of the aerial image. Thus, the known aerial image display device may not allow the user to view the appropriate aerial image when the optical axis direction of the aerial image is not accurately oriented in the direction of the user or the optical axis direction of the aerial image is deviated from an optical axis direction of the aerial image display device on design. Optical axis direction detection systems are awaited for measuring the optical axis direction of an aerial image formed by the aerial image display device and calibrating the optical axis direction of the aerial image.

One or more embodiments of the present disclosure will now be described with reference to the drawings. The drawings used hereafter are schematic and are not necessarily drawn to scale relative to the actual size of each component. For ease of explanation, some of the drawings are defined using an orthogonal XYZ coordinate system. An X-direction may be referred to as a first direction or a height direction. A Y-direction may be referred to as a second direction or a width direction (a horizontal direction or a lateral direction). A Z-direction may be referred to as a third direction or a depth direction.

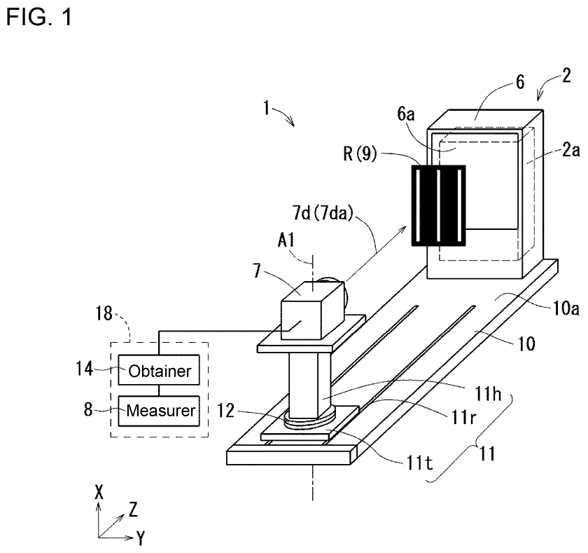

FIGS. 1 to 23 are various types of figures and graphs describing one or more embodiments of the present disclosure. Note that a second strip image is illustrated with luminance higher than the actual luminance for ease of understanding in FIGS. 3 to 5, 8, 9, 11A, 11B, and 11C.

In one embodiment of the present disclosure, an optical axis direction measurement system 1 includes an aerial image display device 2, an imaging device 7 such as a camera, and a measurer 8 as illustrated in FIG. 1. The optical axis direction measurement system 1 may include a device mount 10. The aerial image display device 2 and the imaging device 7 may be mounted on the device mount 10.

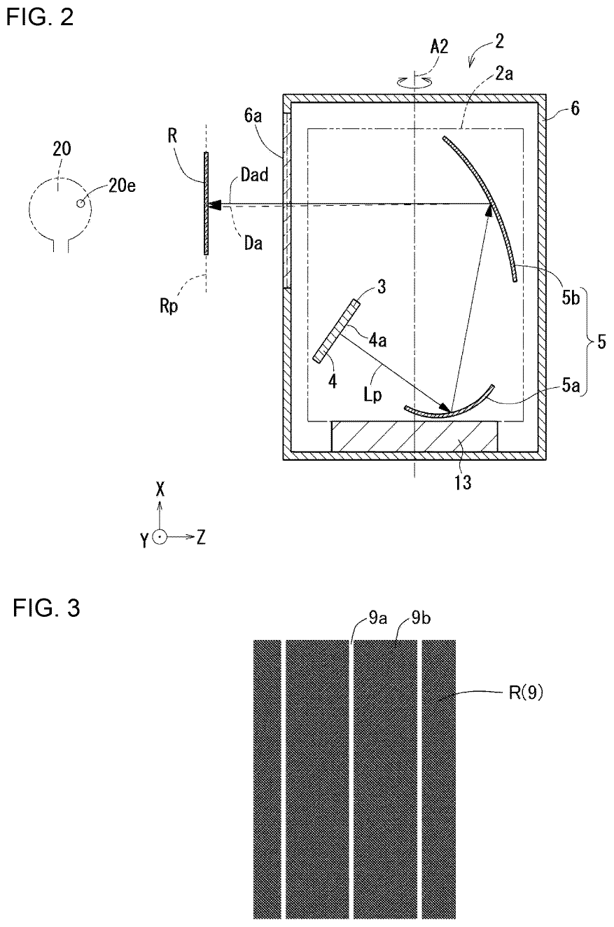

As illustrated in FIG. 2, the aerial image display device 2 includes at least one image display 3 to form an aerial image R as a real image using image light Lp emitted from the image display 3.

In one or more embodiments of the present disclosure, the optical axis direction measurement system 1 may include the aerial image display device 2 that forms the aerial image R as the real image using image light Lp emitted from at least one image display 3 (illustrated in FIG. 2), the imaging device 7 that captures the aerial image R, and the measurer 8 that measures an optical axis direction Da of the aerial image R based on the captured images of multiple imaging portions in an imaging plane (also referred to as a virtual imaging plane) Rp of the aerial image R. This structure allows measurement of the aerial image R formed in the space and being accurately oriented in a direction of a user 20. This structure also allows controlling and calibrating the optical axis direction Da of the aerial image R.

The optical axis direction measurement system 1 may include multiple image displays 3. In this case, the aerial image display device 2 can form multiple aerial images R in the space. The optical axis direction measurement system 1 may include the imaging device 7 that captures multiple aerial images R, and the measurer 8 that measures the optical axis direction Da of each of the aerial images R based on captured images of multiple imaging portions in the imaging plane Rp of each of the aerial images R. The multiple image displays 3 may be, but not limited to, two to five image displays 3.

In the optical axis direction measurement system 1 including multiple image displays 3, one of the multiple image displays 3 may be used to measure the optical axis direction Da of the aerial image R.

The measurer 8 described above that “measures the optical axis direction Da of each of the aerial images R based on captured images” compares characteristic values of the aerial images R, such as luminance, resolution (e.g., a contrast value), or distortion of each of the captured images, or more specifically, calculates characteristic values to determine whether the characteristic values are greater than or equal to or less than or equal to a predetermined threshold or whether differences between the characteristic values are less than or equal to a predetermined threshold.

An aerial image R formed in the space and not being accurately oriented in the direction of the user 20 may cause unevenness in display quality, such as luminance or resolution, of the aerial image R in the imaging plane Rp. In one or more embodiments of the present disclosure, the optical axis direction measurement system 1 reduces the unevenness in display quality, such as luminance or resolution, of the aerial image R in the imaging plane Rp.

The aerial image display device 2 may include a housing 6. In this case, as illustrated in FIG. 2, components 2a of the aerial image display device 2, such as the image display 3 and an optical system 5, are accommodated in the housing 6. The components 2a may include, for example, a circuit, a wire, a cable, a heat dissipator such as a heat sink, a frame-like holder for holding a first optical member 5a, a frame-like holder for holding a second optical member 5b, an adjuster for adjusting an angle and a position of the first optical member 5a, and an adjuster for adjusting an angle and a position of the second optical member 5b. The housing 6 may be made of resin, metal, or ceramic.

The image display 3 includes a display panel 4. The display panel 4 includes a display surface 4a to display an image formed as the aerial image R. More specifically, the display panel 4 emits, from the display surface 4a, the image light Lp that is formed as the aerial image R. The display panel 4 may be a transmissive display panel or a self-luminous display panel. When the display panel 4 is a transmissive display panel, the image display 3 may include an illuminator such as a backlight. When the display panel 4 is a self-luminous display panel, the image display 3 may include no illuminator.

The transmissive display panel may be a liquid crystal panel. The transmissive display panel may have a structure of any known liquid crystal panel. Examples of the known liquid crystal panel include an in-plane switching (IPS) panel, a fringe field switching (FFS) panel, a vertical alignment (VA) panel, and an electrically controlled birefringence (ECB) panel. The transmissive display panel may be a microelectromechanical systems (MEMS) shutter display panel, in addition to the liquid crystal panel. The self-luminous display panel may include multiple self-luminous elements. The self-luminous elements may be any of various types of self-luminous elements including, for example, light-emitting diode (LED) elements, organic electroluminescent (OEL) elements, and inorganic electroluminescent (IEL) elements.

The aerial image display device 2 may include the optical system 5. The optical system 5 forms an aerial image R as a real image using the image light Lp emitted from the display surface 4a of the display panel 4. The optical system 5 may include the first optical member 5a and the second optical member 5b as illustrated in FIG. 2. The first optical member 5a reflects, in a direction different from the direction toward the image display 3, the image light Lp emitted from the image display 3. The second optical member 5b reflects, in a direction different from the direction toward the first optical member 5a, the image light Lp reflected by the first optical member 5a and forms the aerial image R as a real image in the space. Each of the first optical member 5a and the second optical member 5b may be a concave mirror. Each of the first optical member 5a and the second optical member 5b may be a spherical concave mirror, an aspherical concave mirror, or a freeform concave mirror.

The optical system 5 may include the first optical member 5a, the second optical member 5b, and a third optical member (not illustrated). The first optical member 5a reflects, in a direction different from the direction toward the image display 3, the image light Lp emitted from the image display 3. The third optical member reflects, in a direction different from the direction toward the first optical member 5a, the image light Lp reflected by the first optical member 5a. The second optical member 5b reflects, in a direction different from the direction toward the third optical member, the image light Lp reflected by the third optical member and forms the aerial image R as a real image in the space. The third optical member may be a convex mirror. The third optical member may be a spherical convex mirror, an aspherical convex mirror, or a freeform convex mirror.

The housing 6 at least partially includes, as a portion facing the imaging device 7, an image light emitting surface 6a. The image light Lp formed as the aerial image R is emitted from the inside of the housing 6 to the outside of the housing 6 through the image light emitting surface 6a. The image light emitting surface 6a may include, for example, a light-blocking film or a light-blocking glass plate. In this case, the components 2a of the aerial image display device 2 are less visible to the user 20 using the aerial image display device 2, thus improving viewability of the aerial image R.

Although the aerial image display device 2 is designed to have the optical axis direction Da of the aerial image R aligned with the depth direction (Z-direction) as viewed from the user 20, manufacturing tolerances or positioning errors of the components 2a of the aerial image display device 2 may cause an actual optical axis direction Da of the aerial image R formed as a real image by the aerial image display device 2 to deviate from a predetermined optical axis direction Dad of the aerial image display device 2 (hereafter also referred to as an optical axis deviation). The predetermined optical axis direction Dad of the aerial image display device 2 is the optical axis direction of the aerial image R formed by the aerial image display device 2 on design, and is also referred to as the designed optical axis direction Dad. The designed optical axis direction (also referred to as an initial optical axis direction) may be, for example, perpendicular to the width direction (the lateral direction or the horizontal direction) of the housing 6 as viewed from the user 20, or perpendicular to the image light emitting surface 6a. The aerial image display device 2 is mounted on the device mount 10 to have the designed optical axis direction Dad aligned with the depth direction.

The optical axis direction Da of the aerial image R may be perpendicular to a virtual imaging plane Rp. The virtual imaging plane Rp is a virtual plane on which the aerial image R is formed in the space.

The imaging device 7 illustrated in, for example, FIG. 1, is expected to represent eyes 20e of the user 20 illustrated in, for example, FIG. 2, and captures the aerial image R formed by the aerial image display device 2. The imaging device 7 is located in front of the aerial image display device 2. More specifically, the imaging device 7 is spaced from the aerial image display device 2 in the designed optical axis direction (depth direction) Dad of the aerial image display device 2. The imaging device 7 may capture the aerial image R in a predetermined imaging direction 7da. The predetermined imaging direction 7da may be aligned with the designed optical axis direction Dad of the aerial image display device 2. Note that an imaging direction 7d of the imaging device 7 is not limited to the predetermined imaging direction 7da. As described in detail below, the measurer 8 may control the first rotator 12 to rotate the imaging device 7 about a predetermined rotation axis. In other words, the measurer 8 may control the imaging device 7 to capture the aerial image R in a direction different from the depth direction.

The imaging device 7 may include multiple image sensors. Each of the image sensors may be, for example, a charge-coupled device (CCD) image sensor or a complementary metal-oxide semiconductor (CMOS) image sensor. The imaging device 7 may be a camera (e.g., a CCD camera) including the image sensor and an optical device such as an objective lens. In the imaging device 7, an aperture value (also referred to as an F value) may be changeable. In the imaging device 7, the aperture value may be changeable within, for example, a range of 2 to 22.

The imaging device 7 illustrated in FIG. 1 may be tilted with respect to an upper surface 10a of the device mount 10. More specifically, the imaging device 7 may have its height direction (e.g., a direction perpendicular to an upper surface of the imaging device 7) tilted by about 3 to 5° about the rotation axis parallel to its depth direction (Z-direction). This increases the number of samples obtained to measure the optical axis direction Da of the aerial image R, thus allowing accurate measurement of the optical axis direction Da of the aerial image R.

The optical axis direction measurement system 1 includes the measurer 8. As described later, the measurer 8 may function as a controller and a computation processor of the optical axis direction measurement system 1. The optical axis direction measurement system 1 may also include an obtainer 14. As described later, the obtainer 14 may function as a storage device for image data. The measurer 8 and the obtainer 14 may be included in a measurement device 18 (illustrated in FIG. 1). The measurement device 18 may be included in a computing device such as a personal computer (PC), or may be included in the imaging device 7. The measurement device 18 may be a circuit board device including a control circuit and a computation circuit. Signal transmission and reception between the measurement device 18 and the imaging device 7, signal transmission and reception between the obtainer 14 and the imaging device 7, and signal transmission and reception between the obtainer 14 and the measurer 8 may be performed with at least one selected from the group consisting of a wired communication method, a wireless communication method, and an infrared communication method.

The measurer 8 may function as the controller in the optical axis direction measurement system 1. More specifically, the measurer 8 may be connected to all components of the optical axis direction measurement system 1 to control the components. The measurer 8 may include one or more processors. The processors may include at least one of a general-purpose processor configured to cause reading of a specific program to perform a specific function or a processor dedicated to specific processing. The dedicated processor may include an application specific integrated circuit (ASIC). The processors may include a programmable logic device (PLD). The PLD may include a field-programmable gate array (FPGA). The measurer 8 may include at least one of a system on a chip (SoC) or a system in a package (SiP) in which one or more processors are configured to cooperate with one another.

The measurer 8 may include an arithmetic unit for performing computation of characteristic values based on image data of captured images, such as captured images of a test pattern of the aerial image R, to measure the optical axis direction Da of the aerial image R formed by the aerial image display device 2. More specifically, when the imaging device 7 has generated multiple captured images of the respective multiple imaging portions in the imaging plane of the test pattern, the measurer 8 obtains the image data of each of the captured images. The control for obtaining the image data may be performed with the obtainer 14 (illustrated in FIG. 1). The obtainer 14 may be a temporary storage device such as a buffer memory. For example, when having generated multiple captured images, the imaging device 7 may automatically output the image data of each of the multiple captured images to the obtainer 14. For example, when having determined, using determination signals, whether the obtainer 14 has available storage space and whether the obtainer 14 has completed outputting the previous image data to the measurer 8, the imaging device 7 may output the image data to the obtainer 14. The measurer 8 obtains the image data of each of the captured images from the imaging device 7, performs computation based on the image data, and detects and measures the optical axis direction of the test pattern.

The optical axis direction measurement system 1 can systematically detect and measure the optical axis direction Da of the aerial image R formed by the aerial image display device 2. More specifically, the optical axis direction measurement system 1 performs a sequential operation of, capturing, with the imaging device 7, images of, for example, a test pattern of the aerial image R, outputting, with the imaging device 7, image data of the captured images to the measurer 8, and performing, with the measurer 8, computation of characteristic values of the captured images based on the image data to measure the optical axis direction Da of the aerial image R. The optical axis direction measurement system 1 thus automates this sequential operation. The optical axis direction measurement system 1 can also calibrate the optical axis direction Da of the aerial image R formed by the aerial image display device 2 based on the measured optical axis direction Da of the aerial image R. Note that the aerial image display device 2 may be any aerial image display device that can form an aerial image R, and may not be the aerial image display device illustrated in FIG. 2. The aerial image display device 2 may be configured to form the aerial image R using the image light Lp emitted from the image display 3 with an optical element such as a retroreflective plate or a polarizing filter. The aerial image display device 2 may also have another structure.

A test pattern 9 (hereafter also referred to as an aerial image 9 or simply an aerial image R) for measuring the optical axis direction Da of the aerial image R may be a repetition pattern of a first strip image 9a and a second strip image 9b, as illustrated in FIG. 3. Note that FIG. 3 illustrates an ideal test pattern 9 without any blur (no resolution degradation) or optical axis deviation. The first strip image 9a and the second strip image 9b may be elongated in a direction substantially perpendicular to the width direction (Y-direction) in the imaging plane. The aerial image 9 may include at least three first strip images 9a. FIG. 3 illustrates an example of the first strip images 9a being white and the second strip images 9b being black, but these strip images are not limited to this example. The first strip image 9a and the second strip image 9b may differ from each other in at least one of the luminance or the color.

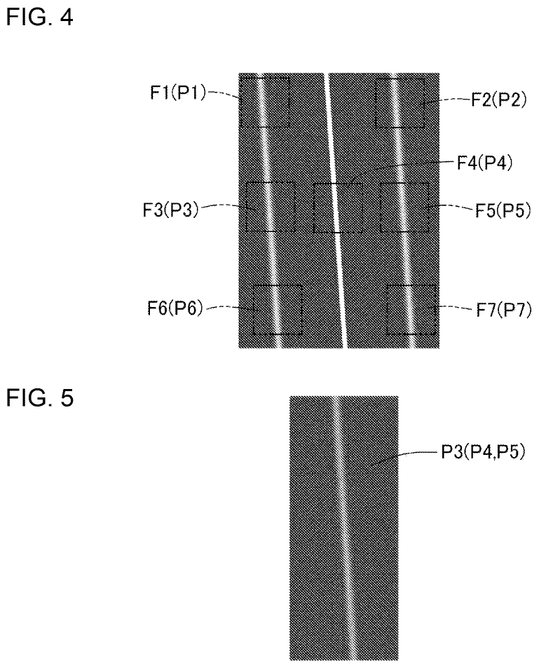

FIG. 4 is an overall view of an example of the aerial image 9 captured with the imaging device 7. The imaging device 7 captures images of multiple imaging portions including imaging portions F3, F4, and F5 as illustrated in FIG. 4. The imaging portion F4 may be located adjacent to the center of the imaging plane Rp (in the X-direction and the Y-direction) of the aerial image 9. The imaging portions F3, F4, and F5 may be aligned in a predetermined direction (e.g., the Y-direction) in the imaging plane Rp of the aerial image 9. The predetermined direction may be, but not limited to, the Y-direction (width direction). The predetermined direction may be the X-direction (the vertical direction or the height direction), or a direction tilted from the X-direction and the Y-direction (oblique direction). Unless otherwise specified, the imaging portions F3, F4, and F5 described hereafter are aligned in the Y-direction (width direction) in the imaging plane Rp of the aerial image 9. Note that the multiple imaging portions may include imaging portions F1, F2, F6, and F7 illustrated in FIG. 4 in addition to the imaging portions F3, F4, and F5.

The aerial image 9 includes captured images P1 to P7 each including at least one first strip image 9a (image portions being white in FIG. 4). Note that the captured images P1 to P7 herein are the captured images of the respective imaging portions F1 to F7. The aerial image 9 may include, as illustrated in FIG. 5, the multiple captured images P1 to P7 each including one first strip image 9a. This facilitates processing of the captured images P3, P4, and P5, thus allowing accurate measurement of the optical axis direction Da of the aerial image 9. Note that FIG. 5 illustrates the captured image P3 being the same as or similar to the captured images P4 and P5.

A distance between the imaging device 7 and the aerial image 9 in the depth direction (Z-direction) may be a predetermined imaging distance (also referred to as an initial set distance). The initial set distance may be, for example, 300 to 700 mm, or 500 mm. The distance between the imaging device 7 and the aerial image 9 may be a distance between the imaging device 7 and a position adjacent to the center of the aerial image 9 (e.g., the imaging portion F4). The imaging device 7 has a predetermined fixed focal length. The predetermined focal length may match the initial set distance. Unless otherwise specified, the distance between the imaging device 7 and the aerial image 9 is hereafter the initial set distance. Note that the distance between the imaging device 7 and the aerial image 9 may not be fixed at the initial set distance. Although described in detail later, the measurer 8 may control the mover 11 to change the distance between the imaging device 7 and the aerial image 9 from the initial set distance. In other words, the measurer 8 may perform defocusing to cause the distance between the imaging device 7 and the aerial image 9 to be different from the focal length of the imaging device 7.

The measurer 8 may control the imaging device 7 to have an aperture value set to less than or equal to 3 (e.g., 2.3) when measuring the optical axis direction Da of the aerial image 9. The aperture value of the imaging device 7 can be set to a relatively small value to reduce (shorten) a depth of field (also referred to as a focal depth of field) of the imaging device 7. More specifically, this can reduce (narrow) the area in which a subject is in focus in the depth direction. This facilitates accurate measurement of the positions of subjects (more specifically, the multiple imaging portions F3, F4, and F5) in the depth direction, thus allowing accurate measurement of the optical axis direction Da of the aerial image 9. The aperture value set to less than or equal to 3 may be greater than a maximum aperture value (e.g., 1.4 to 1.8) and less than or equal to 3.

As illustrated in FIG. 1, the optical axis direction measurement system 1 may include the mover 11 to move the imaging device 7 in the depth direction (Z-direction). The mover 11 is configured to move the imaging device 7 in increments of a predetermined distance ΔZ. The predetermined distance ΔZ may be, for example, about 1 to 5 mm or about 1 to 2 mm. The mover 11 includes, for example, rails 11r, a holder (also referred to as a support) 11h, and a movable table (also referred to as a slider) 11t having an upper surface on which the holder 11h is placed. The rails 11r are located on the upper surface 10a of the device mount 10 and extend in the depth direction. The holder 11h supports and holds the imaging device 7. With the holder 11h holding the imaging device 7, the movable table 11t moves on the rails 11r in the depth direction. The measurer 8 may control the movable table 11t to move in the depth direction.

As illustrated in FIG. 1, the optical axis direction measurement system 1 may include the first rotator 12 to rotate the imaging device 7 about a first rotation axis A1. The first rotation axis A1 may be parallel to a direction (e.g., the X-direction) perpendicular to the predetermined direction (e.g., the Y-direction) in which the multiple imaging portions F3, F4, and F5 are aligned in the imaging plane Rp. The first rotation axis A1 may extend through the imaging device 7. The first rotator 12 is configured to rotate the imaging device 7 in increments of a predetermined angle ΔΘ. The predetermined angle ΔΘ may be, for example, about 0.1 to 2.0° or about 0.5 to 1°. The mover 11 may include the first rotator 12. For example, the first rotator 12 may be located between the movable table 11t and the holder 11h. The first rotator 12 may rotate the holder 11h in the mover 11 and the imaging device 7 held by the holder about the first rotation axis A1. The first rotator 12 may rotate the imaging device 7 about the first rotation axis A1 without rotating the holder 11h in the mover 11. The measurer 8 controls the rotation of the imaging device 7 about the first rotation axis A1. The first rotator 12 may be a stepper motor, a linear motor, an ultrasonic motor, or a manual rotator including a rotation adjuster such as a knob or a screw that is rotatable manually.

As illustrated in FIG. 2, the optical axis direction measurement system 1 may include the second rotator 13 to rotate the aerial image display device 2 about a second rotation axis A2. The second rotation axis A2 may be parallel to a direction (e.g., the X-direction) perpendicular to the predetermined direction in which the imaging portions F3, F4, and F5 are aligned in the imaging plane Rp. The second rotator 13 may collectively rotate the components 2a (the image display 3 and the optical system 5) about the second rotation axis A2 within the housing 6. In other words, the second rotator 13 may collectively rotate the components 2a about the second rotation axis A2 without rotating the housing 6. The measurer 8 controls the rotation of the aerial image display device 2 or the collective rotation of the components 2a about the second rotation axis A2.

### Measurement of Optical Axis Direction of Aerial Image

An operation of the optical axis direction measurement system 1 for measuring the actual optical axis direction Da of the aerial image 9 formed by the aerial image display device 2 will now be described.

An operation of the optical axis direction measurement system 1 for measuring alignment or misalignment of the actual optical axis direction Da of the aerial image 9 with the imaging direction 7d of the imaging device 7 and measuring alignment or misalignment of the actual optical axis direction Da of the aerial image 9 with the designed optical axis direction Dad will be described first. The imaging direction 7d of the imaging device 7 may be an optical axis direction (also referred to as a central axis direction) of an objective lens in a camera or may be a direction perpendicular to an imaging surface of, for example, a CCD image sensor. The imaging direction 7d of the imaging device 7 may be a gaze direction of the eyes 20e of the user 20 directly facing the aerial image display device 2.

When the optical axis direction measurement system 1 measures alignment or misalignment of the actual optical axis direction Da of the aerial image 9 with the imaging direction 7d of the imaging device 7, the aerial image display device 2 directly faces the imaging device 7. When the actual optical axis direction Da of the aerial image 9 is not aligned with the imaging direction 7d of the imaging device 7 (the actual optical axis direction Da is deviated from the imaging direction 7d), the optical axis direction measurement system 1 can measure the amount of deviation of the optical axis direction Da from the imaging direction 7d using a method (described later) for translating the imaging device 7 back and forth in the depth direction (defocusing method) to measure the optical axis direction Da. The optical axis direction measurement system 1 can also rotate the imaging device 7 about the first rotation axis A1 to have the imaging direction 7d aligned with the optical axis direction Da, allowing measurement of the optical axis direction Da and causing the aerial image display device 2 to directly face the imaging device 7 accurately.

Note that the positional deviation of the actual optical axis direction Da from the imaging direction 7d may be in the height direction (X-direction), in the width direction (Y-direction), or in the height direction (X-direction) and the width direction (Y-direction). In each case, the positional deviation can be measured and adjusted to be eliminated.

When the optical axis direction measurement system 1 measures alignment or misalignment of the actual optical axis direction Da of the aerial image 9 with the designed optical axis direction Dad (illustrated in FIG. 2) of the aerial image display device 2, the aerial image display device 2 is accurately placed to directly face the imaging device 7. For example, the aerial image display device 2 may be placed to have the image light emitting surface 6a perpendicular to the imaging direction 7d of the imaging device 7. In this case, the imaging direction 7d is expected to be the predetermined imaging direction 7da (the imaging direction 7da aligned with the designed optical axis direction Dad). In other words, when no positional deviation is detected between the actual optical axis direction Da and the designed optical axis direction Dad, the amount of deviation of the optical axis direction Da from the imaging direction 7da is not measured. When a positional deviation is detected between the actual optical axis direction Da and the designed optical axis direction Dad, the amount of deviation of the optical axis direction Da from the imaging direction 7da is measured using the method (described later) for translating the imaging device 7 back and forth in the depth direction (defocusing method). The deviation of the optical axis direction Da from the designed optical axis direction Dad may be eliminated by, for example, adjusting the arrangement of the components 2a of the aerial image display device 2 or replacing the components 2a to align the optical axis direction Da with the designed optical axis direction Dad.

Note that the positional deviation of the actual optical axis direction Da from the designed optical axis direction Dad may be in the height direction (X-direction), in the width direction (Y-direction), or in the height direction (X-direction) and the width direction (Y-direction). In each case, the positional deviation can be measured and adjusted to be eliminated.

An operation of the optical axis direction measurement system 1 for measuring alignment or misalignment of the actual optical axis direction Da of the aerial image 9 with the designed optical axis direction Dad in a plane perpendicular to the height direction (X-direction) based on the image data of the captured images P3, P4, and P5 will now be described as a specific example, but the operation of the optical axis direction measurement system 1 is not limited to this example.

### Measurement of Optical Axis Direction Based on Characteristic Values of Line Spread Function in Luminance Distribution Waveform

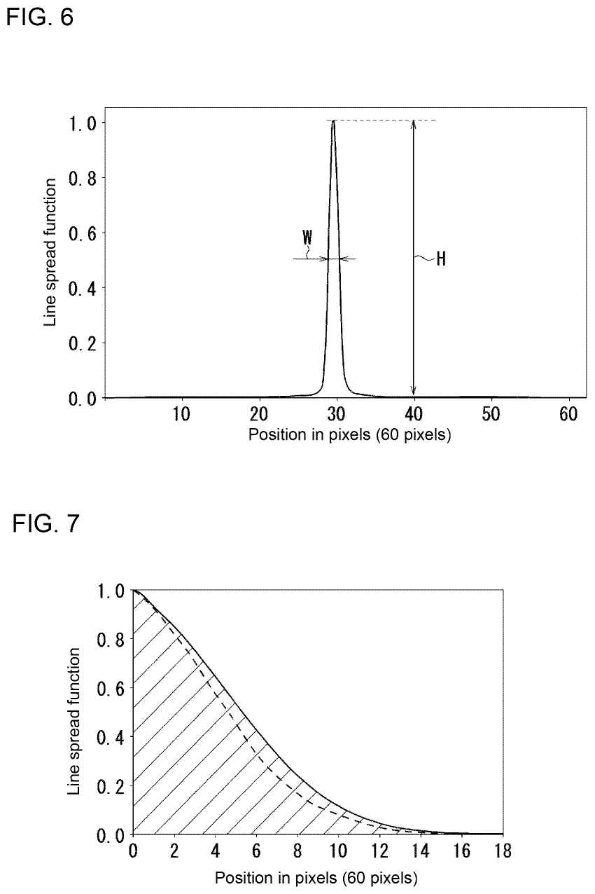

As described above, the measurer 8 obtains, from the imaging device 7, the image data of the captured images P3, P4, and P5 aligned in the Y-direction in the imaging plane Rp of the aerial image 9. The measurer 8 scans, for each of the captured images P3 to P5, luminance values of pixels aligned in the width direction (the lateral direction in FIG. 5), and performs binning to calculate luminance distribution waveforms LSF3, LSF4, and LSF5 as shown in FIG. 6. A luminance distribution waveform has a pulsed profile showing a change in luminance at different positions in the Y-direction. The horizontal axis in FIG. 6 indicates a change in the position in the Y-direction. In FIG. 6, of multiple pixels (e.g., 60 pixels) in the Y-direction, the luminance distribution waveform is displayed with its highest value (peak value) at the position of the 30th pixel. Note that luminance distribution waveforms LSF1 to LSF7 herein are each calculated from the respective captured images P1 to P7. The luminance distribution waveform is also referred to as the LSF. When each of the captured images P3 to P5 is similar to the captured image illustrated in FIG. 5, the line spread functions LSF3 to LSF5 each have a substantially Gauss profile as shown in FIG. 6. A method for measuring the optical axis direction based on characteristic values of the LSFs is hereafter also referred to as an LSF method. Note that the range of values referred to herein as “one value to another value” intends to mean “the two values being inclusive.”

The measurer 8 calculates characteristic values V3, V4, and V5 of the respective line spread functions LSF3 to LSF5. Note that characteristic values V1 to V7 herein refer to the characteristic values of the respective line spread functions LSF1 to LSF7. A characteristic value may be a peak value H or a half width W of a line spread function. The peak value H is a maximum value of the line spread function. For example, for a greater peak value H of the line spread function LSF4, the distance between the imaging portion F4 and the imaging device 7 can be determined to be closer to the focal length of the imaging device 7. The line spread functions LSF3 and LSF5 each have a peak value H in the same or a similar manner. The half width W corresponds to the width of the line spread function having the luminance substantially 50% of the peak value H. The half width W is indicated in units of pixels. For example, for a smaller half width W of the line spread function LSF4, the distance between the imaging portion F4 and the imaging device 7 can be determined to be closer to the focal length of the imaging device 7. The line spread functions LSF3 and LSF5 each have a half width W in the same or a similar manner. A characteristic value may be a combined value obtained from a peak value H and a half width W. The combined value may be a value obtained by dividing the peak value H by the half width W, or may be another value. When the characteristic value is a combined value obtained by dividing the peak value H by the half width W, for a greater combined value of the line spread function LSF4, the distance between the imaging portion F4 and the imaging device 7 can be determined to be closer to the focal length of the imaging device 7. The line spread functions LSF3 and LSF5 each have a combined value in the same or a similar manner.

Note that the line spread function LSF has a half width as an index indicating the degree of the spread of the pulsed (chevron-shaped) function. The half width includes a full width at half maximum (FWHM) and a half width at half maximum (HWHM) that is half the value of the FWHM. A half width typically refers to the FWHM. In one or more embodiments of the present disclosure, the half width thus refers to the FWHM unless otherwise specified. More specifically, in the luminance distribution waveform shown in FIG. 6, the half width (FWHM) corresponds to a value indicating the spread of the line spread function decreasing monotonously around the peak value H, and corresponds to a distance between positions, at both sides of the peak value H, at each of which the line spread function is half the peak value H.

The measurer 8 may calculate multiple differences (specifically, V3-V4, V3-V5, and V4-V5) between the characteristic values V3 to V5. The measurer 8 may determine that the actual optical axis direction Da of the aerial image 9 is aligned with the depth direction (designed optical axis direction Dad) when the absolute values of the multiple differences are less than or equal to a threshold T1 (also referred to as a first predetermined value T1 in the LSF method). The measurer 8 may determine that the optical axis direction Da of the aerial image 9 is not aligned with the depth direction when at least one of the absolute values of the multiple differences is greater than the threshold T1. The threshold T1 may be set as appropriate for the intended specifications of the aerial image display device 2, for example.

For example, the measurer 8 may determine that the optical axis direction Da of the aerial image 9 is aligned with the depth direction when the characteristic values are the peak values H of the line spread functions (values in the range of 0 to 1.0 as shown in FIG. 6) and the absolute values of differences between the multiple characteristic values are less than or equal to the threshold T1 (e.g., 0.2). The threshold T1 being 0.2 corresponds to 20% of a maximum peak value being 1.0. The threshold T1 may be 0.15 (15%), 0.1 (10%), 0.05 (5%), or 0.03 (3%), but is not limited to these values.

The measurer 8 may determine that the optical axis direction Da of the aerial image 9 is aligned with the depth direction when all of the multiple characteristic values V3 to V5 being the peak values H are greater than or equal to a threshold T2 (also referred to as a second predetermined value T2 in the LSF method). The measurer 8 may determine that the optical axis direction Da of the aerial image 9 is not aligned with the depth direction when at least one of the characteristic values V3 to V5 being the peak values H is less than the threshold T2. The threshold T2 may be set as appropriate for the intended specifications of the aerial image display device 2, for example.

For example, the measurer 8 may determine that the optical axis direction Da of the aerial image 9 is aligned with the depth direction when all of the characteristic values being the peak values H of the line spread functions (values in the range of 0 to 1.0 as shown in FIG. 6) are greater than or equal to the threshold T2 (e.g., 0.7). The threshold T2 being 0.7 corresponds to 70% of the maximum peak value being 1.0. The threshold T2 may be 0.8 (80%) or 0.9 (90%), but is not limited to these values.

The measurer 8 may determine that the optical axis direction Da of the aerial image 9 is aligned with the depth direction when all of the characteristic values V3 to V5 being the half widths W are less than or equal to a threshold T3 (also referred to as a second predetermined value T3 in the LSF method). The measurer 8 may determine that the optical axis direction Da of the aerial image 9 is not aligned with the depth direction when at least one of the characteristic values V3 to V5 being the half widths W is greater than the threshold T3. The threshold T3 may be set as appropriate for the intended specifications of the aerial image display device 2, for example.

For example, the measurer 8 may determine that the optical axis direction Da of the aerial image 9 is aligned with the depth direction when all of the multiple characteristic values being the half widths W are less than or equal to the threshold T3 (e.g., the number of pixels being 5). The number of pixels as the threshold T3 may be 4, 3, 2, or 1, but is not limited to these values.

The optical axis direction measurement system 1 can systematically measure alignment or misalignment of the actual optical axis direction Da of the aerial image 9 with the designed optical axis direction Dad based on the characteristic values V3 to V5 of the respective line spread functions LSF3 to LSF5. The optical axis direction measurement system 1 can thus calibrate the optical axis direction Da of the aerial image R formed by the aerial image display device 2. More specifically, at least some of the components 2a of the aerial image display device 2 may be, for example, rearranged or replaced to align the actual optical axis direction Da with the designed optical axis direction Dad.

### Measurement of Optical Axis Direction Based on Area of Modulation Transfer Function

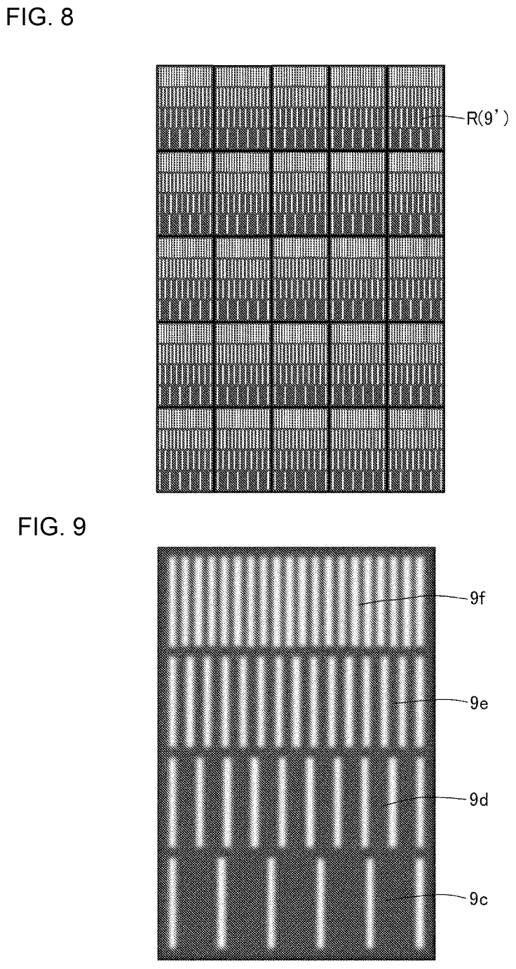

The optical axis direction measurement system 1 can determine alignment or misalignment of the actual optical axis direction Da of the aerial image 9 with the imaging direction 7d or alignment or misalignment of the actual optical axis direction Da of the aerial image 9 with the designed optical axis direction Dad based on the areas of the MTFs. The area of the MTF is numerically about 10 to 20 times greater than a value of a line spread function (LSF) in a luminance distribution waveform (shown in FIG. 6) and a value of the MTF (hereafter also simply referred to as an MTF value). For example, in the graph in FIG. 7, the value of the MTF is about 0.4 at the spatial frequency of 6, but the area of the MTF is about 8 (about 20 times the MTF value). The area of the MTF may thus be used as an index for comparing the resolutions to allow accurate comparison of the resolutions. An operation of the optical axis direction measurement system 1 for determining alignment or misalignment of the actual optical axis direction Da of the aerial image 9 with the designed optical axis direction Dad based on the areas of the MTFs will now be described. The method for measuring the optical axis direction based on the areas of the MTFs is also referred to as an MTF area method. Note that the area of a MTF is an area (hatched area) indicated with the solid line in the graph in FIG. 7. When the optical axis direction Da being misaligned with the designed optical axis direction Dad causes the resolution of an imaging portion to decrease, the area of the MTF of the imaging portion (the area of the MTF indicated with the broken line in the graph in FIG. 7) is reduced from the upper limit value (the area of the MTF indicated with the solid line in the graph in FIG. 7). The area of an MTF changes based on the aperture value of the imaging device 7. The upper limit value thus cannot be a specific value. In the example in FIG. 7, the upper limit value (ideal value) is about 6 to 7.

The measurer 8 transforms, with Fourier transform, each of the line spread functions LSF3 to LSF5 calculated from the respective captured images P3 to P5 to calculate modulation transfer functions MTF3, MTF4, and MTF5, as expressed by Formula 1 below. Note that Fourier transform is, for example, the operation of transforming a function having a pulsed profile into a curve (e.g., a sinusoidal waveform curve, a cosine waveform curve, or a continuous curve as a combined form of the sinusoidal waveform curve and the cosine waveform curve) expressed by continuous values in the frequency range.

$$MTF ( ν ) = \vert C {\int }_{- ∞}^{∞} LSF ( x ) {e}^{- 2 π ix ν} dx \vert \qquad ( 1 )$$

In Formula 1, LSF(x) collectively indicates the line spread functions LSF3 to LSF5 as the functions at positions x in the respective captured images P3 to P5, MTF(v) collectively indicates the modulation transfer functions MTF3 to MTF5 as the functions at spatial frequencies v, and C is a constant for normalizing the MTF(0) to “1.” FIG. 7 is a graph showing an example of the MTF (v). The MTF (v) is an index indicating the resolution based on the contrast of the captured images P3 to P5. For example, for a greater value of the modulation transfer function MTF4 at a higher spatial frequency v (about 6 to 16/mm), the distance between the imaging portion F4 and the imaging device 7 can be determined to be closer to the focal length of the imaging device 7. The modulation transfer functions MTF3 and MTF5 each have a value in the same or a similar manner. In Formula 1, the upper and lower limits in the integrated section may be replaced with finite values (e.g., the spatial frequency of 0 to 18 (1/mm)). This can reduce the processing load of the measurer 8. The modulation transfer functions MTF3 to MTF5 may be calculated using Formula 1 with, for example, a discrete Fourier transform method or a fast Fourier transform method.

The measurer 8 measures areas S3 to S5 obtained by integrating the modulation transfer functions MTF3 to MTF5 on the spatial frequency axis (hereafter also referred to as MTF areas), as expressed by Formula 2 below. Note that MTF areas S1 to S7 herein are obtained by integrating modulation transfer functions MTF1 to MTF7 for the spatial frequency v. In Formula 2, the upper limit in the integrated section may be replaced with a finite value (e.g., the spatial frequency of 0 to 18 (1/mm)). This can reduce the processing load of the measurer 8.

$$S = {\int }_{0}^{∞} MTF ( ν ) d ν \qquad ( 2 )$$

The modulation transfer functions MTF3 to MTF5 may not be calculated by transforming, with Fourier transform, the line spread functions LSF3 to LSF5 calculated from the captured images P3 to P5. Each of the modulation transfer functions MTF3 to MTF5 may be directly calculated from the captured images P3 to P5 using a chart method.

To calculate the modulation transfer functions MTF3 to MTF5 with the chart method, the measurer 8 controls the aerial image display device 2 to form an aerial image 9′ (hereafter also simply referred to as the aerial image R) as illustrated in FIG. 8. Note that FIG. 8 illustrates an ideal aerial image 9′ without any blur (no resolution degradation) or optical axis deviation. In the aerial image 9′, each of the imaging portions F3 to F5 is configured to include multiple square wave charts 9c, 9d, 9e, and 9f each at a different spatial frequency (a pitch in a white strip image). As illustrated in FIG. 9, each of the captured images P3 to P5 thus includes the multiple square wave charts 9c to 9f each at a different spatial frequency v. The measurer 8 controls the imaging device 7 to capture the aerial image 9′, generate the captured images P3 to P5 of the imaging portions F3 to F5, and output the image data of the captured images P3 to P5. The imaging device 7 may not be tilted with respect to the upper surface 10a of the device mount 10 when capturing the aerial image 9′. The measurer 8 calculates, for each of the captured images P3 to P5, a maximum value av and a minimum value by in luminance as well as a contrast value cv=(av−bv)/(av+bv) for a partial image capturing each of the square wave charts 9c to 9f. The measurer 8 normalizes the contrast value cv at each of the spatial frequencies v using the contrast value cv at a lowest spatial frequency v, and calculates a square wave response function (SWRF). The measurer 8 transforms the SWRF to a sinusoidal wave response function to calculate the modulation transfer functions MTF3 to MTF5. For transforming the SWRF to the sinusoidal wave response function, a Coltman's formula may be used. The Coltman's formula may be used up to the fourth term or to the twelfth term.

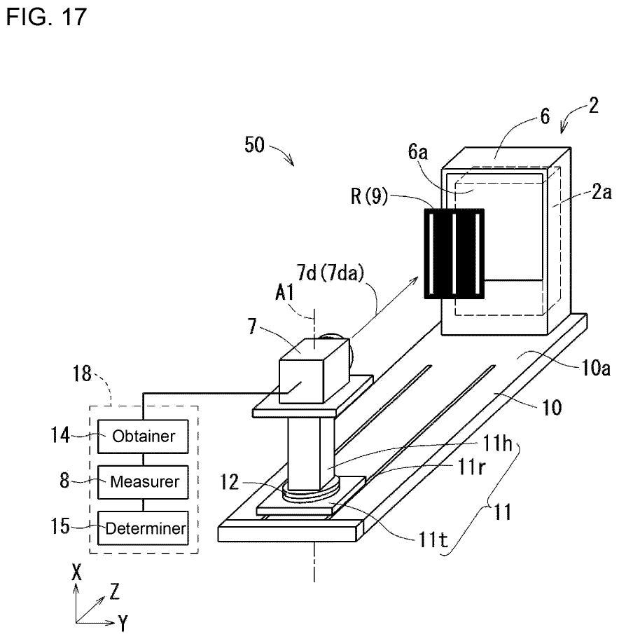

The modulation transfer function MTF may not be calculated by transforming, with Fourier transform, a line spread function LSF calculated from a captured image. The MTF value of the modulation transfer function MTF may be identified by analyzing the captured image using an image analysis software program and comparing the analyzed image with a reference image separately stored in, for example, a reference table. For example, each of the reference images corresponds to one MTF value (also referred to as a reference MTF value). The MTF value of an analyzed image may be determined as the reference MTF value corresponding to a reference image when the analyzed image matches the reference image or the analyzed image is the most approximate to the reference image. For example, the measurer 8 (illustrated in FIGS. 1 and 17) or a determiner 15 (illustrated in FIG. 17) may perform this determination. This may allow faster processing to determine the MTF value of an analyzed image. The image analysis software program may include an artificial intelligence (AI) software program for performing image recognition in which the captured image is analyzed to at least detect or extract a specific pattern. The AI software program may perform image recognition in which the image data is directly analyzed to at least detect or extract a specific pattern.

In the same or a similar manner, an MTF area may not be calculated by transforming, with Fourier transform, a line spread function LSF calculated from a captured image. The MTF area may be identified by analyzing the captured image using an image analysis software program and comparing the analyzed image with the reference image separately stored in, for example, the reference table. For example, each of the reference images corresponds to one MTF area (also referred to as a reference MTF value). The MTF area of an analyzed image may be determined as the reference MTF area corresponding to a reference image when the analyzed image matches the reference image or the analyzed image is the most approximate to the reference image. For example, the measurer 8 (illustrated in FIGS. 1 and 17) or the determiner 15 (illustrated in FIG. 17) may perform this determination. This may allow faster processing to determine the MTF area of an analyzed image. The image analysis software program may include the AI software program described above.

The measurer 8 may calculate multiple differences (specifically, S3-S4, S3S5, and S4-S5) between the MTF areas S3 to S5. The measurer 8 may determine that the actual optical axis direction Da of the aerial image 9′ is aligned with the depth direction (designed optical axis direction Dad) when all of multiple absolute values of the multiple differences are less than or equal to a threshold T4 (also referred to as a first predetermined value T4 in the MTF area method). The measurer 8 may determine that the optical axis direction Da of the aerial image 9′ is not aligned with the depth direction when at least one of the absolute values of the multiple differences is greater than the threshold T4. The threshold T4 may be set as appropriate for the intended specifications of the aerial image display device 2, for example.

The measurer 8 may determine that the actual optical axis direction Da of the aerial image 9′ is aligned with the depth direction when all of the MTF areas S3 to S5 are greater than or equal to a threshold T5 (also referred to as a second predetermined value T5 in the MTF area method). The measurer 8 may determine that the actual optical axis direction Da of the aerial image 9′ is not aligned with the depth direction when at least one of the MTF areas S3 to S5 is less than the threshold T5. The threshold T5 may be set as appropriate for the intended specifications of the aerial image display device 2, for example.

The optical axis direction measurement system 1 can systematically measure alignment or misalignment of the actual optical axis direction Da of the aerial image 9′ with the designed optical axis direction Dad based on the MTF areas S3 to S5. The areas of the modulation transfer functions MTF are less likely to be susceptible to, for example, external light. The MTF areas S3 to S5 can thus be used to accurately measure alignment or misalignment of the actual optical axis direction Da of the aerial image 9′ with the designed optical axis direction Dad. The optical axis direction measurement system 1 can thus accurately calibrate the actual optical axis direction Da of the aerial image R formed by the aerial image display device 2.

An operation of the optical axis direction measurement system 1 for measuring an optical axis deviation of the aerial image 9 (a deviation of the actual optical axis direction Da from the designed optical axis direction Dad) and calibrating the optical axis deviation of the aerial image display device 2 will now be described. The measurer 8 may measure the optical axis deviation of the actual optical axis direction Da of the aerial image 9 from the designed optical axis direction Dad when determining that the actual optical axis direction Da of the aerial image 9 is not aligned with the designed optical axis direction (depth direction) Dad. The measurer 8 may measure the optical axis deviation of the actual optical axis direction Da of the aerial image 9 from the designed optical axis direction Dad without determining alignment or misalignment of the actual optical axis direction Da of the aerial image 9 with the designed optical axis direction Dad.

Measurement of Optical Axis Deviation with Defocusing

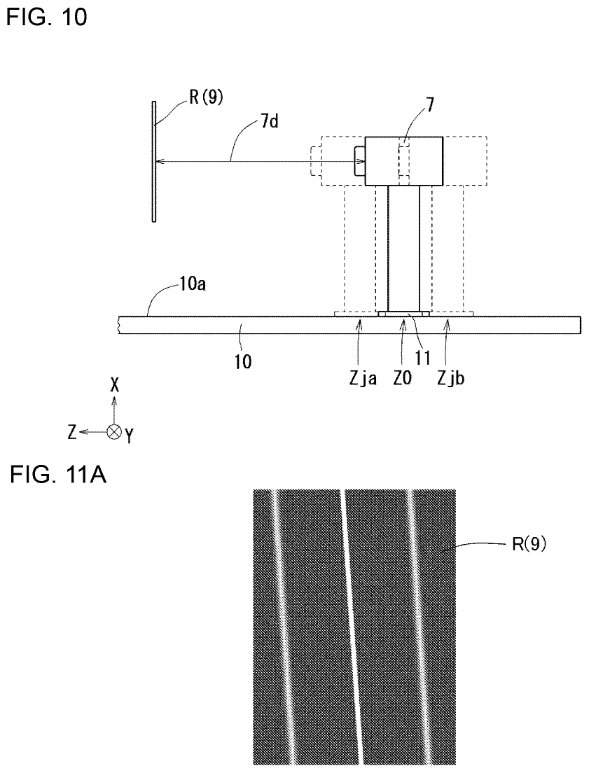

An operation of the optical axis direction measurement system 1 for measuring the optical axis deviation by moving the imaging device 7 in the imaging direction 7d will now be described. As illustrated in FIG. 10, the measurer 8 controls the mover 11 to move the imaging device 7 in the imaging direction 7d (Z-direction) to position the imaging device 7 at one of multiple positions each with a different coordinate (Z-coordinate) in the imaging direction 7d. The Z coordinates of the multiple positions are collectively indicated with Zj, where Zj=Z0+j×ΔZ. Z0 is an initial coordinate of the imaging device 7 in the imaging direction 7d and is the Z coordinate of the imaging device 7 when the distance between the imaging device 7 and the aerial image 9 is the initial set distance. ΔZ may be, for example, about 0.1 to 5 mm or about 0.2 to 2 mm. The value j is an integer in the range of −m1≤j≤m2 (m1 and m2 are natural numbers). The values m1 and m2 may be, but not limited to, natural numbers being 1 to 20 inclusive.

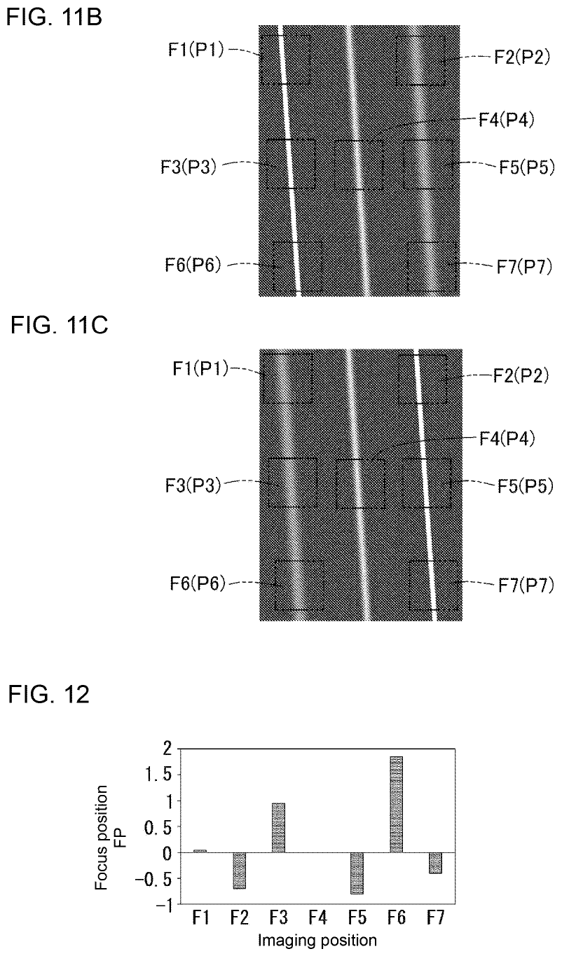

The measurer 8 controls the imaging device 7 to capture the aerial image 9 in the imaging direction 7d at each of the positions with the Z-coordinates expressed by Zj (−m1≤j≤m2). FIG. 11A is an example of the aerial image 9 captured with the imaging device 7 at a position with the Z-coordinate of Z0. FIG. 11B is an example of the aerial image 9 captured with the imaging device 7 at a position with the Z-coordinate of Zja (ja is a positive integer). FIG. 11C is an example of the aerial image 9 captured with the imaging device 7 at a position with the Z-coordinate of Zjb (jb is a negative integer). The imaging device 7 has the focal length fixed at the initial set distance. The blurring of the imaging portions F3, F4, and F5 thus changes with the movement of the imaging device 7. The imaging device 7 outputs, to the measurer 8, image data of (m1+m2+1) captured images P3 to P5 for each of the imaging portions F3 to F5. The measurer 8 obtains, from the imaging device 7, the image data of the (m1+m2+1) captured images P3 to P5 for each of the imaging portions F3 to F5. The measurer 8 may obtain the image data from the imaging device 7 through the obtainer 14.

### Measurement of Optical Axis Deviation Based on Characteristic Value of Line Spread Function in Luminance Distribution Waveform

Measurement of an optical axis deviation of the aerial image 9 based on the characteristic values of the line spread functions will be described first. The measurer 8 calculates, for each of the imaging portions F3 to F5, (m1+m2+1) line spread functions LSF3, LSF4, and LSF5 based on image data of (m1+m2+1) captured images P3 to P5 to calculate (m1+m2+1) characteristic values V3 to V5. The characteristic values V3 to V5 hereafter are peak values H of the respective line spread functions LSF3 to LSF5 or combined values obtained by dividing the peak values H by the respective half widths W. The measurer 8 measures, for each of the imaging portions F3 to F5, a maximum value V_{MAX} of the respective (m1+m2+1) characteristic values V3 to V5, and measures the Z-coordinate (hereafter also referred to as a focus position) of the imaging device 7 when each of the characteristic values V3 to V5 is the corresponding maximum value V_{MAX}.

FIG. 12 is a graph showing focus positions FP3 to FP5 of the respective imaging portions F3 to F5. Note that focus positions FP1 to FP7 herein refer to the focus positions when the respective characteristic values V1 to V7 are each at the maximum value V_{MAX}. FIG. 12 also shows the focus positions FP1, FP2, FP6, and FP7 of the respective imaging portions F1, F2, F6, and F7. The focus positions FP1, FP2, FP6, and FP7 can be calculated in the same manner as or in a similar manner to the focus positions FP3 to FP5. In FIG. 12, the focus positions FP3 to FP5 of the respective imaging portions F3 to F5 are shown with the focus position FP4 of the imaging portion F4 as a reference position (0 mm). FIG. 12 shows the focus positions FP3 to FP5 of the respective imaging portions F3 to F5 with an optical axis deviation.

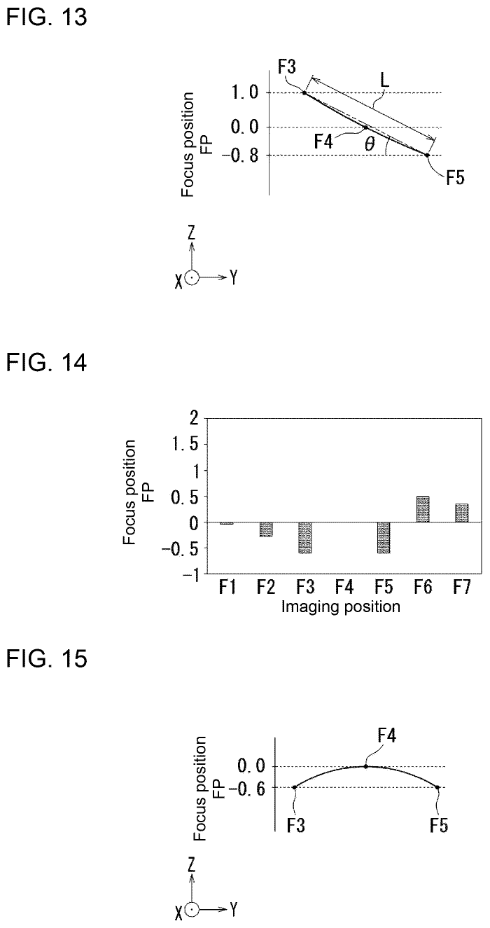

In FIG. 12, the focus position FP3 (+1.0 mm) of the imaging portion F3 and the focus position FP5 (−0.8 mm) of the imaging portion F5 have different symbols. This indicates an optical axis deviation, as shown in FIG. 13. More specifically, the focus position FP3 is 1.0 mm from the focal length of the imaging device 7 toward the imaging device 7, and the focus position FP5 is 0.8 mm from the focal length of the imaging device 7 away from the imaging device 7. The measurer 8 determines that the optical axis of the aerial image 9 is deviated from the depth direction by an angle θ satisfying Formula 3 below when the focus position FP3 and the focus position FP5 have different symbols.

$$sin θ = \frac{\vert FP 3 \vert + \vert FP 5 \vert}{L} \qquad ( 3 )$$

In Formula 3, |FP3| is the absolute value of the focus position FP3, and |FP5| is the absolute value of the focus position FP5 (refer to FIG. 12). L is the designed length of the aerial image 9 in the width direction (Y-direction).

The measurer 8 controls the second rotator 13 (illustrated in FIG. 2), which collectively rotates the components 2a of the aerial image display device 2, to rotate the aerial image display device 2 about the second rotation axis A2 by the angle θ when determining that the optical axis direction Da of the aerial image 9 is deviated from the designed optical axis direction (depth direction) Dad by the angle θ. This calibrates the optical axis deviation of the aerial image R formed by the aerial image display device 2. This also allows the user to view the aerial image R of high display quality with a smaller optical axis deviation. The measurer 8 controls the second rotator 13 to rotate the aerial image display device 2 clockwise or counterclockwise by the angle θ as viewed from above the device mount 10. The measurer 8 may determine the rotation direction of the aerial image display device 2 based on the symbols of the focus positions FP3 and FP5 to cause the optical axis direction Da of the aerial image 9 to be parallel to (or to align with) the designed optical axis direction Dad. The second rotator 13 may be a stepper motor, a linear motor, an ultrasonic motor, or a manual rotator including a rotation adjuster such as a knob or a screw that is rotatable manually.

FIG. 14 shows the focus positions FP3 to FP5 of the respective imaging portions F3 to F5 without an optical axis deviation. FIG. 14 also shows the focus positions FP1, FP2, FP6, and FP7 of the respective imaging portions F1, F2, F6, and F7. The focus positions FP1, FP2, FP6, and FP7 can be calculated in the same manner as or in a similar manner to the focus positions FP3 to FP5. In FIG. 14, the focus position FP3 (−0.6 mm) of the imaging portion F3 and the focus position FP5 (−0.6 mm) of the imaging portion F5 have the same symbol. This indicates no optical axis deviation (or a smaller optical axis deviation), as shown in FIG. 15. The measurer 8 determines that the actual optical axis direction Da of the aerial image 9 is not deviated from the designed optical axis direction (depth direction) Dad and may not rotate the components 2a of the aerial image display device 2 when the focus position FP3 and the focus position FP5 have the same symbol.

The optical axis direction measurement system 1 performs the operation as described above when the peak values H or the combined values obtained by dividing the peak values H by the respective half widths W are used as the characteristic values V3 to V5 of the respective line spread functions LSF3 to LSF5. For the characteristic values V3 to V5 of the respective line spread functions LSF3 to LSF5 being the half widths W, the measurer 8 measures, for each of the imaging portions F3 to F5, a minimum value V_{MIN} of the respective (m1+m2+1) characteristic values V3 to V5, and sets the Z-coordinates of the imaging device 7 as the focus positions FP3 to FP5 when each of the characteristic values V3 to V5 is the corresponding minimum value V_{MIN}. The minimum value V_{MIN} may be the same as or similar to the threshold T1.

The optical axis direction measurement system 1 can systematically measure, by defocusing the imaging device 7, the optical axis deviation of the actual optical axis direction Da of the aerial image 9 from the designed optical axis direction Dad based on the characteristic values V3 to V5 of the respective line spread functions LSF3 to LSF5. The optical axis direction measurement system 1 can thus calibrate the optical axis direction Da of the aerial image R formed by the aerial image display device 2.

### Measurement of Optical Axis Deviation Based on Area of Modulation Transfer Function MTF

Measurement of an optical axis deviation (a deviation of the optical axis direction Da from the designed optical axis direction Dad) of the aerial image 9 (or the aerial image 9′) based on the areas of modulation transfer functions MTF will now be described. The measurer 8 calculates, for each of the imaging portions F3 to F5, (m1+m2+1) modulation transfer functions MTF3 to MTF5 based on the image data of (m1+m2+1) captured images P3 to P5 to measure (m1+m2+1) MTF areas S3 to S5. The measurer 8 measures, for each of the imaging portions F3 to F5, a maximum value S_{MAX} of the respective (m1+m2+1) MTF areas S3 to S5, and measures the Z-coordinate (each of the focus positions FP3 to FP5) of the imaging device 7 when each of the MTF areas S3 to S5 is the corresponding maximum value S_{MAX}.

The measurer 8 can measure, based on the focus positions FP3 to FP5 when each of the MTF areas S3 to S5 is the corresponding maximum value S_{MAX}, the optical axis deviation (tilt angle θ) of the aerial image 9 and calibrate the optical axis deviation of the aerial image R formed by the aerial image display device 2. The operation of the optical axis direction measurement system 1 for measuring the optical axis deviation of the aerial image 9 based on the MTF areas S3 to S5 and calibrating the optical axis deviation of the aerial image 9 is the same as or similar to the operation of the optical axis direction measurement system 1 for measuring the optical axis deviation of the aerial image 9 based on the characteristic values V3 to V5 and calibrating the optical axis deviation of the aerial image 9, and will not be described in detail.

The measurer 8 calculates, for each of the imaging portions F3 to F5, (m1+m2+1) line spread functions LSF3 to LSF5 based on image data of (m1+m2+1) captured images P3 to P5 and transforms the (m1+m2+1) line spread functions LSF3 to LSF5 with Fourier transform to calculate (m1+m2+1) modulation transfer functions MTF3 to MTF5. The measurer 8 may also calculate, for each of the imaging portions F3 to F5, (m1+m2+1) modulation transfer functions MTF3 to MTF5 based on the image data of (m1+m2+1) captured images P3 to P5 using the chart method.

The optical axis direction measurement system 1 can systematically measure, by defocusing the imaging device 7, the optical axis deviation of the actual optical axis direction Da of the aerial image 9 from the designed optical axis direction Dad based on changes in the MTF areas S3 to S5 resulting from the movement of the imaging device 7. As illustrated in FIG. 10, defocusing is performed by moving the imaging device 7 back and forth in the imaging direction 7d to change the degree of focus (the degree of being in focus or the degree of blurring of the captured image) in each of the imaging portions of the aerial image 9. The areas of the modulation transfer functions MTF are less likely to be susceptible to, for example, external light. The MTF areas S3 to S5 can thus be used to accurately measure alignment or misalignment of the actual optical axis direction Da of the aerial image 9 with the designed optical axis direction Dad. The optical axis direction measurement system 1 can thus accurately calibrate the actual optical axis direction Da of the aerial image R formed by the aerial image display device 2.

Measurement of Optical Axis Deviation with Rotation

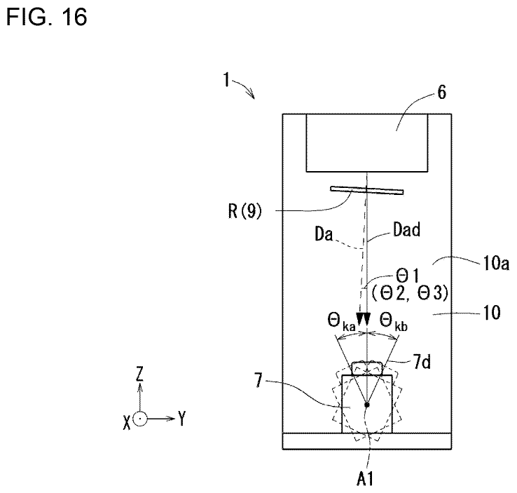

An operation of the optical axis direction measurement system 1 for measuring an optical axis deviation (a deviation of the optical axis direction Da from the designed optical axis direction Dad) by rotating the imaging device 7 about the first rotation axis A1 will now be described. As illustrated in FIG. 16, the measurer 8 controls the first rotator 12 to rotate the imaging device 7 about the first rotation axis A1, allowing the imaging device 7 to capture aerial images 9 in multiple imaging directions 7d each having a different angle with the depth direction (Z-direction). The multiple imaging directions 7d and the depth direction (designed optical axis direction Dad) define angles collectively indicated with Θk. Θk is also referred to as an imaging angle. Θk is expressed by Θk=k×ΔΘ, where ΔΘ may be, for example, about 0.1 to 2° or about 0.5 to 1°, k is an integer in the range of −n1≤k≤n2 (n1 and n2 are natural numbers), and n1 and n2 may be, but not limited to, natural numbers being 1 to 20 inclusive. FIG. 16 illustrates the rotation angles of the imaging device 7 being Θka (ka is a positive integer) and Θkb (kb is a negative integer).

The measurer 8 controls the imaging device 7 to capture the aerial image 9 in each direction having an imaging angle expressed by Θk(−n1≤k≤n2). The imaging device 7 outputs, to the measurer 8, image data of (n1+n2+1) captured images P3 to P5 for each of the imaging portions F3 to F5. The measurer 8 obtains, from the imaging device 7, the image data of the (n1+n2+1) captured images P3 to P5 for each of the imaging portions F3 to F5. The measurer 8 may obtain the image data from the imaging device 7 through the obtainer 14.

### Measurement of Optical Axis Deviation Based on Characteristic Value of Line Spread Function

Measurement of an optical axis deviation of the aerial image 9 based on the characteristic values of the line spread functions will be described first. The measurer 8 calculates, for each of the imaging portions F3 to F5, (n1+n2+1) line spread functions LSF3 to LSF5 based on image data of (n1+n2+1) captured images P3 to P5 to calculate (n1+n2+1) characteristic values V3 to V5. The characteristic values V3 to V5 may be the peak values H or the half widths W of the respective line spread functions LSF3 to LSF5. Each of the characteristic values V3 to V5 may be a combined value obtained by dividing the peak value H by the half width W.

The measurer 8 may calculate, for each of the imaging angles Θk, multiple differences (specifically, V3-V4, V3-V5, and V4-V5) between the characteristic values V3 to V5. The measurer 8 may determine that the actual optical axis direction Da of the aerial image 9 is tilted by a tilt angle Θ1 from the depth direction (designed optical axis direction Dad) when, for an imaging angle Θ1, the absolute values of the multiple differences are less than or equal to the threshold T4 (also referred to as the first predetermined value in the LSF method). The first predetermined value T4 may be set as appropriate for the intended specifications of the aerial image display device 2, for example.

The measurer 8 may determine that the actual optical axis direction Da of the aerial image 9 is tilted by a tilt angle Θ2 from the designed optical axis direction Dad when, for an imaging angle Θ2, all of the characteristic values V3 to V5 being the peak values H are greater than or equal to the threshold T5 (also referred to as the second predetermined value in the LSF method). The second predetermined value T5 may be set as appropriate for the intended specifications of the aerial image display device 2, for example.

The measurer 8 may determine that the actual optical axis direction Da of the aerial image 9 is tilted by a tilt angle Θ3 from the designed optical axis direction Dad when, for an imaging angle Θ3, all of the characteristic values V3 to V5 being the half widths W are less than or equal to a threshold T6 (also referred to as the second predetermined value in the LSF method). The threshold T6 may be set as appropriate for the intended specifications of the aerial image display device 2, for example.

The measurer 8 controls the second rotator 13 to rotate the aerial image display device 2 about the second rotation axis A2 by a rotation angle being equal to the tilt angle Θ1, Θ2, or Θ3 when determining that the actual optical axis direction Da of the aerial image 9 is deviated from the designed optical axis direction (depth direction) Dad by the tilt angles Θ1, Θ2, or Θ3. This calibrates the optical axis deviation of the aerial image R formed by the aerial image display device 2. This also allows the user to view the aerial image R of high display quality with a smaller optical axis deviation. The measurer 8 controls the second rotator 13 to rotate the aerial image display device 2 clockwise or counterclockwise by a rotation angle being equal to the tilt angle Θ1, Θ2, or Θ3 as viewed from above the device mount 10. The measurer 8 may determine the rotation direction of the aerial image display device 2 to eliminate the optical axis deviation of the aerial image 9.

The optical axis direction measurement system 1 can systematically measure, by rotating the imaging device 7, the optical axis deviation of the actual optical axis direction Da of the aerial image 9 from the designed optical axis direction Dad based on changes in the characteristic values V3 to V5 resulting from the rotation of the imaging device 7. The optical axis direction measurement system 1 can thus calibrate the optical axis direction Da of the aerial image R formed by the aerial image display device 2.

### Measurement of Optical Axis Deviation Based on Area of Modulation Transfer Function MTF

Measurement of an optical axis deviation of the aerial image 9 based on the areas of modulation transfer functions MTF will now be described. The measurer 8 calculates, for each of the imaging portions F3 to F5, (n1+n2+1) modulation transfer functions MTF based on image data of (n1+n2+1) captured images P3 to P5 to measure (n1+n2+1) MTF areas S3 to S5.

The measurer 8 may calculate, for each of the imaging angles Θk, multiple differences (specifically, S3-S4, S3-S5, and S4-S5) between the MTF areas S3 to S5. The measurer 8 may determine that the actual optical axis direction Da of the aerial image 9 is tilted by a tilt angle Θ4 from the depth direction (designed optical axis direction Dad) when, for an imaging angle Θ4, the absolute values of the multiple differences are less than or equal to a threshold T7 (also referred to as a first predetermined value in the MTF area method). The first predetermined value T7 may be set as appropriate for the intended specifications of the aerial image display device 2, for example.

The measurer 8 may determine that the actual optical axis direction Da of the aerial image 9 is tilted by a tilt angle Θ5 from the designed optical axis direction Dad when, for an imaging angle Θ5, all of the MTF areas S3 to S5 are greater than or equal to a threshold T8 (also referred to as a second predetermined value in the MTF area method). The predetermined value T8 may be set as appropriate for the intended specifications of the aerial image display device 2, for example.

The measurer 8 calculates, for each of the imaging portions F3, F4, and F5, (n1+n2+1) line spread functions LSF3 to LSF5 based on image data of (n1+n2+1) captured images P3 to P5 and transforms the (n1+n2+1) line spread functions LSF3 to LSF5 with Fourier transform to calculate (n1+n2+1) modulation transfer functions MTF3 to MTF5. The measurer 8 may also calculate, for each of the imaging portions F3 to F5, (n1+n2+1) modulation transfer functions MTF3 to MTF5 based on the image data of (n1+n2+1) captured images P3 to P5 using the chart method.

The optical axis direction measurement system 1 can systematically measure, by rotating the imaging device 7, the optical axis deviation of the actual optical axis direction Da of the aerial image 9 from the designed optical axis direction Dad based on the MTF areas S3 to S5. The areas of the modulation transfer functions MTF are less likely to be susceptible to, for example, external light. The MTF areas S3 to S5 can thus be used to accurately measure alignment or misalignment of the actual optical axis direction Da of the aerial image 9 with the designed optical axis direction Dad. The optical axis direction measurement system 1 can thus accurately calibrate the optical axis direction Da of the aerial image R formed by the aerial image display device 2.

The operation of the optical axis direction measurement system 1 for measuring an optical axis deviation in the height direction (X-direction) perpendicular to the width direction (Y-direction) based on the multiple captured images P3 to P5 of the imaging portions F3 to F5 aligned in the width direction (Y-direction) in the imaging plane Rp of the aerial image 9, and calibrating the optical axis deviation as described above is not limited to the above example. The optical axis direction measurement system 1 can also measure an optical axis deviation in the width direction (Y-direction) perpendicular to the height direction (X-direction) based on multiple captured images (e.g., the multiple captured images P1, P3, and P6 or the multiple captured images P2, P5, and P7) of the multiple imaging portions (e.g., the multiple imaging portions F1, F3, and F6 or the multiple imaging portions F2, F5, and F7) aligned in the height direction (X-direction) in the imaging plane Rp of the aerial image 9, and calibrate the optical axis deviation. The optical axis direction measurement system 1 can also measure optical axis deviations in the height direction (X-direction) and the width direction (Y-direction) based on multiple captured images of the multiple imaging portions F1 to F7 in the imaging plane Rp of the aerial image 9, and calibrate these optical axis deviations. The line spread functions LSF1, LSF2, LSF6, and LSF7 can be calculated in the same manner as or in a similar manner to the line spread functions LSF3, LSF4, and LSF5. The characteristic values V1, V2, V6, and V7 can be calculated in the same manner as or in a similar manner to the characteristic values V3, V4, and V5. The modulation transfer functions MTF1, MTF2, MTF6, and MTF7 can be calculated in the same manner as or in a similar manner to the modulation transfer functions MTF3, MTF4, and MTF5. The MTF areas S1, S2, S6, and S7 can be measured in the same manner as or in a similar manner to the MTF areas S3, S4, and S5.

The above embodiment is implemented as, but not limited to, the optical axis direction measurement system 1. The above embodiment may also be implemented as, for example, an optical axis direction measurement method using the optical axis direction measurement system 1. The above embodiment may also be implemented as, for example, a program for controlling the optical axis direction measurement system 1.

The optical axis direction measurement method using the LSF method includes capturing the aerial image R and calculating characteristic values of the luminance distribution of captured images obtained by capturing multiple imaging portions of the aerial image R to detect and measure the optical axis direction Da of the aerial image R based on the multiple characteristic values. The optical axis direction measurement method using the MTF area method includes capturing the aerial image R, calculating and measuring areas obtained by integrating, on the spatial frequency axis, the MTFs of the captured images obtained by capturing multiple imaging portions of the aerial image R, and detecting and measuring the optical axis direction Da of the aerial image R based on the areas of the MTFs.

The optical axis direction measurement method using the LSF method may also include capturing the aerial image R and calculating characteristic values of the luminance distribution of the captured image obtained by capturing one imaging portion of the aerial image R to measure the optical axis direction Da of the aerial image R based on the characteristic values. For example, the optical axis direction measurement method may calculate changes in the characteristic values of the luminance distribution in multiple portions of one captured image, such as an upper end, middle, and lower end portions of the captured image, obtained by capturing one imaging portion of the aerial image R as illustrated in FIG. 5. The changes may be analyzed to measure the optical axis direction Da of the aerial image R. The changes in the characteristic values of the luminance distribution may be analyzed by analyzing one captured image using the image analysis software program for analyzing images and by comparing the analyzed image with reference images stored separately in, for example, the reference table. For example, each of the reference images corresponds to one optical axis direction Da (also referred to as a reference optical axis direction Da). The optical axis direction Da of an analyzed image may be determined as the reference optical axis direction Da corresponding to a reference image when the analyzed image matches the reference image or the analyzed image is the most approximate to the reference image. For example, the measurer 8 (illustrated in FIGS. 1 and 17) or the determiner 15 (illustrated in FIG. 17) may perform this determination. This allows fast measurement of the optical axis direction Da of the aerial image R. The image analysis software program may include an AI software program for performing image recognition in which the captured image is analyzed to at least detect or extract a specific pattern. The AI software program may perform image recognition in which the image data is directly analyzed to at least detect or extract a specific pattern.

The optical axis direction measurement method using the MTF area method may also include capturing the aerial image R, measuring an area obtained by integrating, on the spatial frequency axis, the MTF of the captured image obtained by capturing one imaging portion of the aerial image R, and measuring the optical axis direction Da of the aerial image R based on the area of the MTF. For example, the optical axis direction measurement method may calculate a change in the MTF area in multiple portions of the captured image, such as an upper end, middle, and lower end portions of the captured image, obtained by capturing one imaging portion of the aerial image R as illustrated in FIG. 5. The changes may be analyzed to measure the optical axis direction Da of the aerial image R. The change in the MTF area may be analyzed by analyzing one captured image using the image analysis software program for analyzing images and by comparing the analyzed image with reference images stored separately in, for example, the reference table. For example, each of the reference images corresponds to one optical axis direction Da (also referred to as a reference optical axis direction Da). The optical axis direction Da of an analyzed image may be determined as the reference optical axis direction Da corresponding to a reference image when the analyzed image matches the reference image or the analyzed image is the most approximate to the reference image. For example, the measurer 8 (illustrated in FIGS. 1 and 17) or the determiner 15 (illustrated in FIG. 17) may perform this determination. This allows fast measurement of the optical axis direction Da of the aerial image R. The image analysis software program may include the AI software program described above.

The program for controlling the optical axis direction measurement system 1 using the LSF method controls the measurer 8 to calculate the characteristic values of the luminance distribution of captured images obtained by capturing multiple imaging portions of the aerial image R to measure the optical axis direction Da of the aerial image R based on the multiple characteristic values. The program may be a software program or a graphic controller stored in, for example, a random-access memory (RAM) or a read-only memory (ROM) in a drive element such as an integrated circuit (IC) or a large-scale integration (LSI) circuit included in a controller of the measurer 8. The program may also be a software program or a graphic controller stored in, for example, a RAM or a ROM in a drive element included in an external controller. In this case, the measurer 8 performs control through the external controller. The program for controlling the optical axis direction measurement system 1 using the MTF area method controls the measurer 8 to measure areas obtained by integrating, on the spatial frequency axis, the MTFs of the captured images obtained by capturing multiple imaging portions of the aerial image R and measure the optical axis direction Da of the aerial image R based on multiple MTF areas. This program may be the same as or similar to the software program described above.

The measurer 8 may be a part of the optical axis direction measurement device. The optical axis direction measurement device may include the obtainer 14 and the measurer 8. The obtainer 14 is configured to receive image data of the captured images P3 to P5 captured with the imaging device 7. The obtainer 14 is configured to output the image data of the captured images P3 to P5 to the measurer 8. The obtainer 14 may obtain, from the imaging device 7, image data of the captured images P3 to P5 of the multiple imaging portions F3 to F5 in the imaging plane of the aerial image R, and output the obtained image data to the measurer 8. In other words, the obtainer 14 may include a storage for image data and an input-output controller for controlling input and output of the image data stored in the storage. The optical axis direction measurement device may also include an imager for capturing the aerial image R formed as a real image in the space and the measurer 8. The imager may be the imaging device 7.

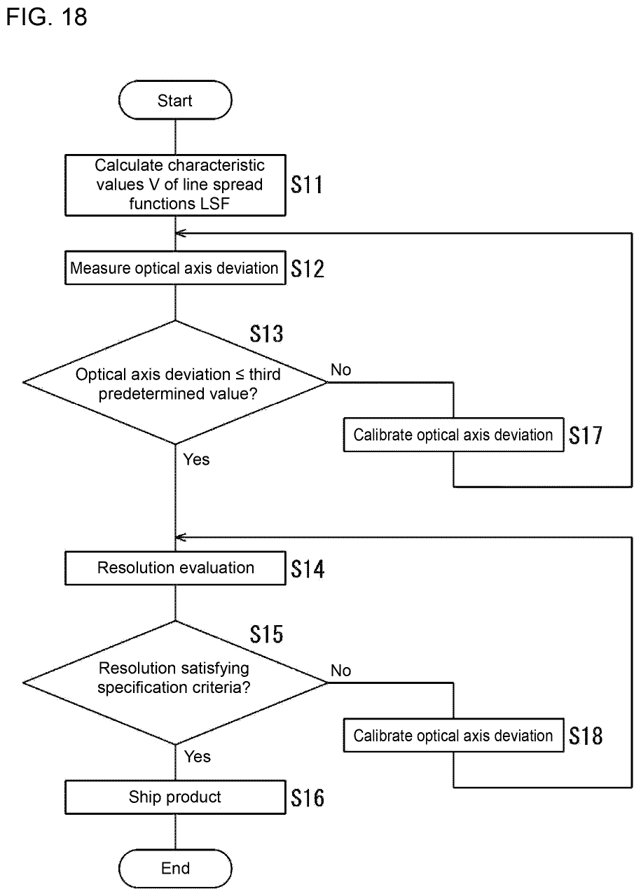

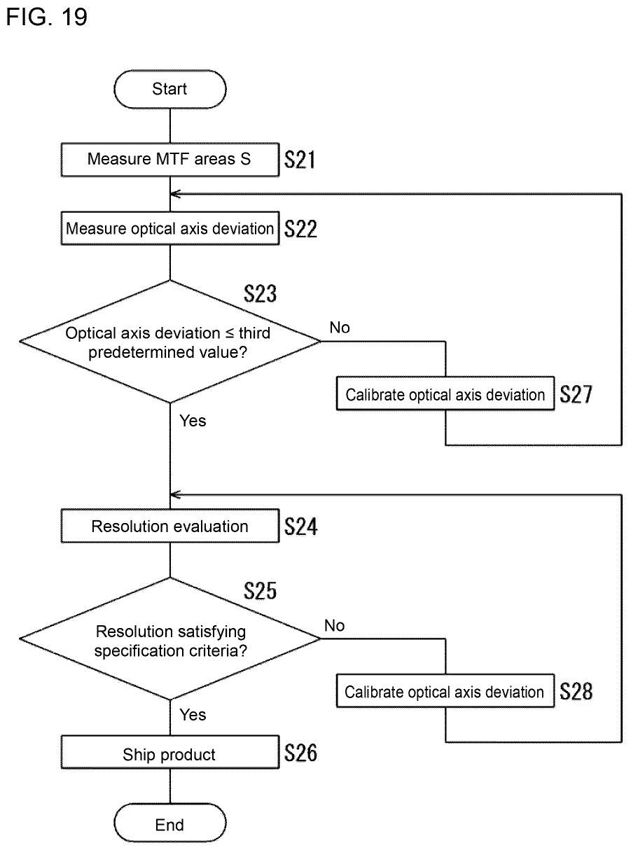

The acceptance determination system according to one embodiment of the present disclosure will now be described. FIG. 17 is a perspective view of the acceptance determination system according to one embodiment of the present disclosure. FIG. 18 is a flowchart describing an example operation of the acceptance determination system in FIG. 17. FIG. 19 is a flowchart describing another example operation of the acceptance determination system in FIG. 17.

In one embodiment of the present disclosure, an acceptance determination system 50 determines, based on a deviation (an optical axis deviation) of the actual optical axis direction Da of the aerial image R from the predetermined optical axis direction of the aerial image display device 2, whether the aerial image display device 2 is an acceptable product that can be shipped. The predetermined optical axis direction of the aerial image display device 2 is the optical axis direction of the aerial image display device on design, and is also referred to as the designed optical axis direction Dad. The acceptance determination system 50 calculates the modulation transfer function MTF used as a resolution index (performance index) of the aerial image display device 2 when determining the aerial image display device 2 to be an acceptable product. The acceptance determination system 50 measures and calibrates the optical axis deviation when not determining the aerial image display device 2 to be an acceptable product.

As illustrated in FIG. 17, the acceptance determination system 50 includes the optical axis direction measurement system 1 described above and the determiner 15. The determiner 15 may be included in the measurement device 18. The determiner 15 may function as the controller in the acceptance determination system 50. More specifically, the determiner 15 may be connected to all components of the acceptance determination system 50 to control the components. The determiner 15 may include one or more processors. The processors may include at least one of a general-purpose processor configured to cause reading of a specific program to perform a specific function or a processor dedicated to specific processing. The dedicated processor may include an ASIC. The processors may include a PLD. The PLD may include the FPGA. The determiner may include at least one of the SoC or the SiP in which one or more processors are configured to cooperate with one another.

The determiner 15 may control the measurer 8 to measure the optical axis deviation of the actual optical axis direction Da of the aerial image R from the designed optical axis direction Dad of the aerial image display device 2. The determiner 15 determines the aerial image display device 2 to be an acceptable product (or the aerial image display device 2 that can be shipped) when the optical axis deviation is less than or equal to a third predetermined value T9. The third predetermined value T9 may be set as appropriate for the intended specifications of the aerial image display device 2.

The determiner 15 controls the aerial image display device 2 to form a test pattern for evaluating the resolution of the aerial image R formed by the aerial image display device 2 when determining that the aerial image display device 2 is an acceptable product. The test pattern may be the aerial image 9 as illustrated in FIG. 3 or the aerial image 9′ as illustrated in FIG. 8. The determiner 15 controls the imaging device 7 to have the aperture value set to a value greater than 3. In other words, the determiner 15 controls the imaging device 7 to have the aperture value set to a value greater than the aperture value used to measure the optical axis deviation (less than or equal to 3). The determiner 15 also controls the imaging device 7 to capture images of multiple imaging portions of the test pattern. The multiple imaging portions may include at least the imaging portions F1, F4, and F7 or the imaging portions F2, F4, and F6 (refer to FIG. 4). The multiple imaging portions may be the imaging portions F1, F2, F4, F6, and F7. A distance between the imaging device 7 and the test pattern in the depth direction (Z-direction) may be an initial set distance. The imaging device 7 may change its distance from the test pattern in the depth direction to capture images of the test pattern. The determiner 15 controls the imaging device 7 to generate multiple captured images of the respective multiple imaging portions in the imaging plane Rp of the test pattern and output image data of each of the captured images. The determiner 15 calculates the characteristic value or the MTF based on the LSF of each of the captured images based on the image data of the corresponding captured image. The characteristic value or the MTF based on the LSF can be used as the resolution index of the aerial image display device 2. The determiner 15 may control the imaging device 7 to have the aperture value set to about 5 to 8. In this case, the resolution index of the aerial image display device 2 can be set closer to a resolution index of the eyes 20e of the user 20 actually viewing the test pattern.

The determiner 15 may determine whether the product is acceptable (or whether the product satisfies its specification criteria) based on the MTF used as the resolution index of the aerial image display device 2. For example, the determiner 15 may determine, at a spatial frequency of 3/mm, that the aerial image display device 2 satisfies the specification criteria when the value of the MTF used as the resolution index is greater than or equal to 0.6, and determine that the aerial image display device 2 does not satisfy the specification criteria when the value of the MTF is less than 0.6. When the aerial image display device 2 fails to satisfy the specification criteria, the determiner 15 may control the optical axis direction measurement system 1 to calibrate the optical axis direction. The determiner 15 may determine the aerial image display device 2 to be an unacceptable product when the aerial image display device 2 fails to satisfy the specification criteria.

The acceptance determination system 50 can systematically measure the optical axis deviation of the actual optical axis direction Da of the aerial image R from the designed optical axis direction Dad of the aerial image display device 2, and calibrate the actual optical axis direction Da of the aerial image R formed by the aerial image display device 2. The acceptance determination system 50 can systematically measure the resolution index of the aerial image display device 2 to increase the resolution of the aerial image display device 2.

An operation of the acceptance determination system 50 will now be described with reference to the flowcharts in FIGS. 18 and 19. In the flowchart, “step” is abbreviated as “S”, “positive” in determination control is indicated by “Yes”, and “negative” in determination control is indicated by “No.” In measurement of the optical axis deviation of the actual optical axis direction Da of the aerial image R from the designed optical axis direction Dad of the aerial image display device 2, multiple imaging portions in the imaging plane Rp of the aerial image R are hereafter referred to as imaging portions F. The imaging portions F may include the multiple imaging portions F3 to F5, the multiple imaging portions F1, F3, and F6, the multiple imaging portions F2, F5, and F7, or the multiple imaging portions F1 to F7. The multiple captured images obtained by capturing the imaging portions F are referred to as captured images P. The line spread functions, the characteristic values of the line spread functions, the modulation transfer functions, and the areas of the modulation transfer functions calculated from the captured images P are respectively referred to as line spread functions LSF, characteristic values V, modulation transfer functions MTF, and MTF areas S. In evaluation of the resolution of the aerial image display device 2 determined to be an acceptable product, the multiple imaging portions in the imaging plane Rp of the aerial image R are referred to as imaging portions F′. The imaging portions F′ may include the multiple imaging portions F1, F4, and F7, the multiple imaging portions F2, F4, and F6, or the multiple imaging portions F1, F2, F4, F6, and F7. The captured images obtained by capturing the imaging portions F′ are referred to as captured images P′. The line spread functions and the modulation transfer functions calculated from the captured images P are respectively referred to as line spread functions LSF′ and modulation transfer functions MTF′.

FIG. 18 is a flowchart showing the operation of the acceptance determination system 50 for performing, using the characteristic values of the LSFs as references, acceptance determination of the aerial image display device 2 as a product. In a first process, the acceptance determination system 50 measures an optical axis deviation of the actual optical axis direction Da of the aerial image R measured by the measurer 8 from the predetermined optical axis direction (designed optical axis direction Dad) of the aerial image display device 2 based on the characteristic values of the LSFs, and determines the aerial image display device 2 to be an acceptable product when the deviation is less than or equal to the third predetermined value. In a second process, the acceptance determination system 50 sets, when the aerial image display device 2 is determined to be an acceptable product in the first process, the aperture value of the imaging device 7 to a value greater than 3 (an aperture value appropriate for the focal point depth of the eyes 20e of the user 20) and calculates the MTF of each of the captured images obtained by capturing multiple imaging portions of the aerial image R. The final acceptance determination of the aerial image display device 2 is performed based on the MTF values or the MTF areas. An aperture value of the imaging device 7 set to a value greater than 3 may be 5 to 9 or 8.

Once the processing in the flowchart in FIG. 18 starts, the aerial image display device 2 forms an aerial image R as a real image in a space in S11. The aerial image R may be the aerial image 9 as illustrated in FIG. 3. The imaging device 7 sets the aperture value to a value less than or equal to 3, captures images of the imaging portions F in the imaging plane Rp of the aerial image R, and outputs the captured images P. The imaging device 7 may be defocused or rotated to output captured images P. The measurer 8 calculates the line spread functions LSF and the characteristic values V of the line spread functions LSF based on the captured images P.

Note that the determination as to whether the resolution of the aerial image R satisfies the specification criteria for the product may be performed in S11 based on the line spread functions LSF and the characteristic values V of the line spread functions LSF of the captured images P.

In S12, the determiner 15 measures the optical axis deviation of the actual optical axis direction Da of the aerial image R from the designed optical axis direction Dad of the aerial image display device 2 based on the characteristic values V of the line spread functions LSF.

In S13, the determiner 15 determines whether the optical axis deviation is less than or equal to the third predetermined value. When the optical axis deviation is less than or equal to the third predetermined value (Yes), the processing advances to S14. When the optical axis deviation is greater than the third predetermined value (No), the processing advances to S17.

Note that when the optical axis deviation is less than or equal to the third predetermined value, the determination as to whether the resolution of the aerial image R satisfies the specification criteria for the product may be performed in S13.

In S14, the aerial image display device 2 forms an image of a test pattern for resolution evaluation. The imaging device 7 sets the aperture value to a value greater than 3 and captures images of the imaging portions F′ of the test pattern for resolution evaluation. The measurer 8 calculates the MTF's based on the captured images P′. The measurer 8 may calculate the MTF's by transforming the LSF's with Fourier transform or by using the chart method.

In S15, the determiner 15 determines whether the aerial image display device 2 satisfies the specification criteria based on the MTF's. For example, the determiner 15 may determine, at a spatial frequency v of 3/mm, that the aerial image display device 2 satisfies the specification criteria when the values of the MTF's are greater than or equal to 0.6, and determine that the aerial image display device 2 does not satisfy the specification criteria when the values of the MTF's are less than 0.6. When the aerial image display device 2 satisfies the specification criteria (Yes), the processing advances to S16 to determine the aerial image display device 2 to be an acceptable product that can be shipped. When the aerial image display device 2 does not satisfy the specification criteria (No), the processing advances to S18.

When the optical axis deviation is greater than the third predetermined value in S13 (No), the optical axis deviation is calibrated in S17. In S17, the aerial image display device 2 forms the aerial image R. The aerial image R may be the aerial image 9 as illustrated in FIG. 3 or the aerial image 9′ as illustrated in FIG. 8. The imaging device 7 sets the aperture value to a value less than or equal to 3, captures images of the imaging portions F in the imaging plane Rp of the aerial image R, and outputs the captured images P. The imaging device 7 may be defocused or rotated to output captured images P. The measurer 8 measures, based on the captured images P, the optical axis deviation of the actual optical axis direction Da of the aerial image R from the designed optical axis direction Dad of the aerial image display device 2 and calibrates the optical axis deviation. The measurer 8 may measure the MTFs and the MTF areas S to measure the optical axis deviation based on the MTF areas S. In this case, the optical axis deviation can be accurately measured and accurately calibrated. The measurer 8 may calculate the MTFs by transforming the LSFs with Fourier transform or by using the chart method. After the optical axis deviation is calibrated in S17, the processing returns to determination in S13. Note that when the optical axis deviation is determined to be greater than the third predetermined value again in S13, the processing may advance to S17. When the processing continuously advances from S13 to S17 for a predetermined number of times (e.g., three times), the aerial image display device 2 may be determined to be an unacceptable product. In this case, the optical axis deviation may be caused by another factor other than the components 2a of the aerial image display device 2 (e.g., the housing 6 or a light-transmissive substrate or a light-transmissive screen for the image light emitting surface 6a).

When the aerial image display device 2 does not satisfy the specification criteria in S15 (No), the optical axis deviation is calibrated in S18. In S18, the aerial image display device 2 forms the aerial image R. The aerial image R may be the aerial image 9 as illustrated in FIG. 3 or the aerial image 9′ as illustrated in FIG. 8. The imaging device 7 sets the aperture value to a value greater than 3 (e.g., 8), captures images of the imaging portions F in the imaging plane Rp of the aerial image R, and outputs the captured images P. The imaging device 7 may be defocused or rotated to output captured images P. The measurer 8 measures, based on the captured images P, the optical axis deviation of the actual optical axis direction Da of the aerial image R from the designed optical axis direction Dad of the aerial image display device 2 and calibrates the optical axis deviation. The measurer 8 may measure the MTFs and the MTF areas S to measure the optical axis deviation based on the MTF areas S. In this case, the optical axis deviation can be accurately measured and accurately calibrated. The measurer 8 may calculate the MTFs by transforming the LSFs with Fourier transform or by using the chart method. After the optical axis deviation is calibrated in S18, the processing returns to S14 to calculate the MTF's and then advances to S15. When the aerial image display device 2 is determined to not satisfy the specification criteria again in S15, the processing may advance to S18. When the processing continuously advances from S15 to S18 for a predetermined number of times (e.g., three times), the aerial image display device 2 may be determined to be an unacceptable product. In this case, the optical axis deviation may be caused by another factor (described above) other than the components 2a of the aerial image display device 2.

FIG. 19 is a flowchart showing the operation of the acceptance determination system 50 for performing, using the values of MTFs or the MTF areas as references, acceptance determination of the aerial image display device 2 as a product. In a first process, the acceptance determination system 50 measures an optical axis deviation of the actual optical axis direction Da of the aerial image R measured by the measurer 8 from the predetermined optical axis direction (designed optical axis direction Dad) of the aerial image display device 2 based on the values of MTFs or the MTF areas, and determines the aerial image display device 2 to be an acceptable product when the deviation is less than or equal to the third predetermined value. In a second process, the acceptance determination system 50 sets, when the aerial image display device 2 is determined to be an acceptable product in the first process, the aperture value of the imaging device 7 to a value greater than 3 (e.g., 8) and calculates the MTF of each of the captured images obtained by capturing multiple imaging portions of the aerial image R. The final acceptance determination of the aerial image display device 2 is performed based on the MTF values or the MTF areas. An aperture value of the imaging device 7 set to a value greater than 3 may be 5 to 9 or 8.

Once the processing in the flowchart in FIG. 19 starts, the aerial image display device 2 forms the aerial image R as a real image in a space in S21. The aerial image R may be the aerial image 9 as illustrated in FIG. 3 or the aerial image 9′ as illustrated in FIG. 8. The imaging device 7 sets the aperture value to a value less than or equal to 3, captures images of the imaging portions F in the imaging plane Rp of the aerial image R, and outputs the captured images P. The imaging device 7 may be defocused or rotated to output captured images P. The measurer 8 calculates the MTFs based on the captured images P to measure the MTF areas S. The measurer 8 may calculate the MTFs by transforming the LSFs with Fourier transform or by using the chart method.

Note that the determination as to whether the resolution of the aerial image R satisfies the specification criteria for the product may be performed in S21 based on the MTF areas S of the captured images P.

In S22, the determiner 15 may measure the optical axis deviation of the actual optical axis direction Da of the aerial image R from the designed optical axis direction Dad of the aerial image display device 2 based on the MTF areas S.

In S23, the determiner 15 determines whether the optical axis deviation is less than or equal to the third predetermined value. When the optical axis deviation is less than or equal to the third predetermined value (Yes), the processing advances to S24. When the optical axis deviation is greater than the third predetermined value (No), the processing advances to S27.

Note that when the optical axis deviation is less than or equal to the third predetermined value, the determination as to whether the resolution of the aerial image R satisfies the specification criteria for the product may be performed in S23.

In S24, the aerial image display device 2 forms an image of a test pattern for resolution evaluation. The imaging device 7 sets the aperture value to a value greater than 3 (e.g., 8), captures images of the imaging portions F′ of the test pattern for the resolution evaluation, and outputs the captured images P′. The measurer 8 calculates the MTF's based on the captured images P′. The measurer 8 may calculate the MTF's by transforming the LSFs with Fourier transform or by using the chart method.

In S25, the determiner 15 determines whether the aerial image display device 2 satisfies the specification criteria based on the MTF's. For example, the determiner 15 may determine, at a spatial frequency v of 3/mm, that the aerial image display device 2 satisfies the specification criteria when the values of the MTF's are greater than or equal to 0.6, and determine that the aerial image display device 2 does not satisfy the specification criteria when the values of the MTF's are less than 0.6. When the aerial image display device 2 satisfies the specification criteria (Yes), the processing advances to S26 to determine the aerial image display device 2 to be an acceptable product that can be shipped. When the aerial image display device 2 does not satisfy the specification criteria (No), the processing advances to S28.

When the optical axis deviation is greater than the third predetermined value in S23 (No), the optical axis deviation is calibrated in S27. In S27, the aerial image display device 2 forms the aerial image R. The aerial image R may be the aerial image 9 as illustrated in FIG. 3 or the aerial image 9′ as illustrated in FIG. 8. The imaging device 7 sets the aperture value to a value less than or equal to 3, captures images of the imaging portions F in the imaging plane Rp of the aerial image R, and outputs the captured images P. The imaging device 7 may be defocused or rotated to output captured images P. The measurer 8 measures, based on the captured images P, the optical axis deviation of the actual optical axis direction Da of the aerial image R from the designed optical axis direction Dad of the aerial image display device 2 and calibrates the optical axis deviation. The measurer 8 may measure the optical axis deviation based on the MTF areas S. In this case, the optical axis deviation can be accurately measured and accurately calibrated. The measurer 8 may calculate the MTFs by transforming the LSFs with Fourier transform or by using the chart method. After the optical axis deviation is calibrated in S27, the processing returns to determination in S23. Note that when the optical axis deviation is determined to be greater than the third predetermined value again in S23, the processing may advance to S27. When the processing continuously advances from S23 to S27 for a predetermined number of times (e.g., three times), the aerial image display device 2 may be determined to be an unacceptable product. In this case, the optical axis deviation may be caused by another factor (described above) other than the components 2a of the aerial image display device 2.

When the aerial image display device 2 does not satisfy the specification criteria in S25 (No), the optical axis deviation is calibrated in S28. In S28, the aerial image display device 2 forms the aerial image R. The aerial image R may be the aerial image 9 as illustrated in FIG. 3 or the aerial image 9′ as illustrated in FIG. 8. The imaging device 7 sets the aperture value to a value greater than 3 (e.g., 8), captures images of the imaging portions F in the imaging plane Rp of the aerial image R, and outputs the captured images P. The imaging device 7 may be defocused or rotated to output captured images P. The measurer 8 measures, based on the captured images P, the optical axis deviation of the actual optical axis direction Da of the aerial image R from the designed optical axis direction Dad of the aerial image display device 2 and calibrates the optical axis deviation. The measurer 8 may measure the MTFs and the MTF areas S to measure the optical axis deviation based on the MTF areas S. In this case, the optical axis deviation can be accurately measured and accurately calibrated. The measurer 8 may calculate the MTFs by transforming the LSFs with Fourier transform or by using the chart method. After the optical axis deviation is calibrated in S28, the processing returns to S24 to calculate the MTF's and then advances to S25. When the aerial image display device 2 is determined to not satisfy the specification criteria again in S25, the processing may advance to S28. When the processing continuously advances from S25 to S28 for a predetermined number of times (e.g., three times), the aerial image display device 2 may be determined to be an unacceptable product. In this case, the optical axis deviation may be caused by another factor (described above) other than the components 2a of the aerial image display device 2.

The above embodiment is implemented as, but not limited to, the acceptance determination system. The above embodiment may also be implemented as, for example, an acceptance determination method using the acceptance determination system. The above embodiment may also be implemented as, for example, a program for controlling the acceptance determination system.

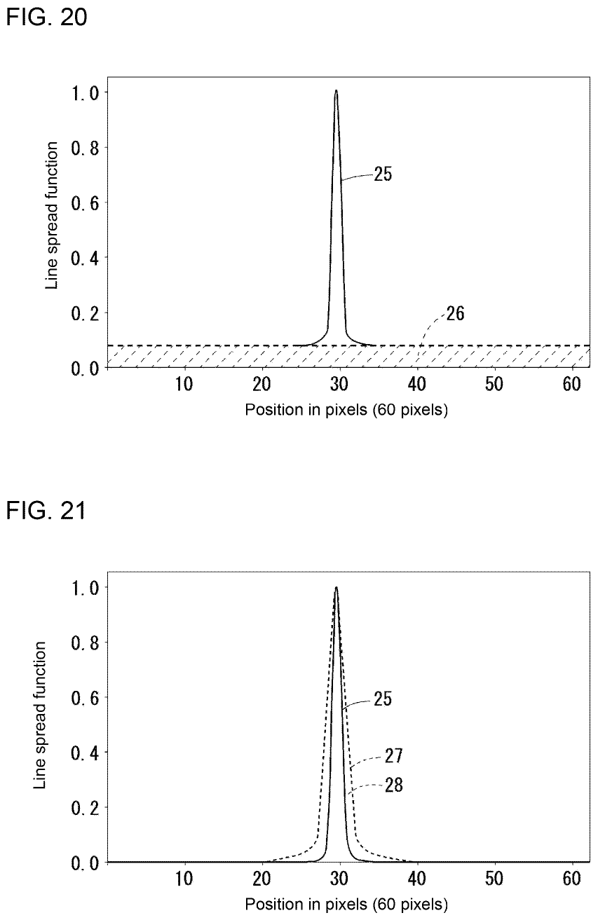

FIG. 20 is a graph of a line spread function in a luminance distribution waveform shown in FIG. 6 corrected by removing background noise. The optical axis direction measurement system 1 illustrated in FIG. 1 may be used in an environment in which external ambient light such as indoor illumination light or sunlight enters the imager of the imaging device 7. In this case, the external ambient light acting as background noise 26 increases the overall signal strength (signal level) of the luminance distribution waveform 25. A component of the background noise 26 may be removed by correction (also referred to as first correction). The first correction may be performed by, for example, a signal processor or a correction processor included in the imaging device 7, or by the measurer 8.

FIG. 21 is a graph of the line spread function in a luminance distribution waveform shown in FIG. 6 corrected by removing a resolution degrading component caused by resolution degradation of the imaging device. The optical axis direction measurement system 1 illustrated in FIG. 1 may have resolution degradation caused by, for example, performance of the optical system in the imaging device 7, performance of the image sensor (light receiving element) in the imager (light receiver), or pixel density of pixels including the light receiver. In this case, the luminance distribution waveform 25 is entirely widened, causing a degraded luminance distribution waveform 27 indicating degraded sharpness. A resolution degrading component 28 caused by resolution degradation of the imaging device 7 may be corrected by subtracting the resolution degrading component 28 from the degraded luminance distribution waveform 27 (also referred to as second correction). The second correction may be performed by, for example, the signal processor or the correction processor included in the imaging device 7, or by the measurer 8.

The resolution degrading component 28 may be prestored in a data storage in the signal processor or the correction processor in the imaging device 7, or in a data storage (data table) in the measurer 8. The second correction may be performed by retrieving data of the resolution degrading component 28 from the data storage. The data of the resolution degrading component 28 may be obtained in a manner described below. First, the test pattern illustrated in FIG. 3 is displayed on the display panel 4, which is a liquid crystal panel, for example. Data of an ideal luminance distribution waveform 25 (also referred to as first data) is obtained based on image signal data to be input into pixel groups in the display panel 4 including the test pattern. Data of the degraded luminance distribution waveform 27 including the resolution degrading component 28 (also referred to as second data) is then obtained based on captured images of the test pattern formed in the space and captured with the imaging device 7. The difference between the second data and the first data can be used to obtain data of the resolution degrading component 28.

The first correction and the second correction may both be performed to correct the line spread function in the luminance distribution waveform 25.

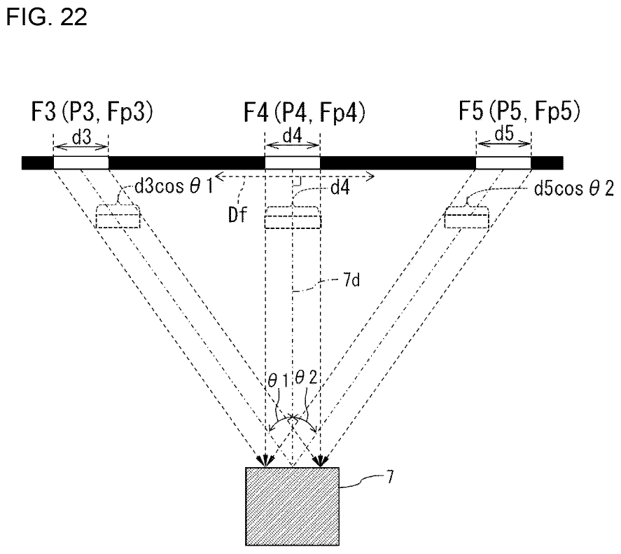

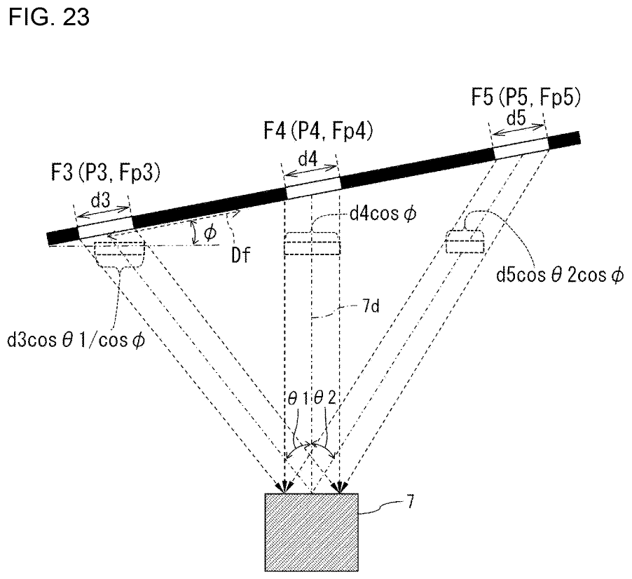

As illustrated in FIGS. 22 and 23, the luminance distribution waveform 25 may be corrected as appropriate for the positional relationship between the imaging direction 7d of the imaging device 7 and alignment positions (Fp3, Fp4, and Fp5) and an alignment direction Df of the imaging portions F3, F4, and F5 illustrated in FIG. 4. In FIG. 22, the imaging direction 7d and the alignment direction Df are perpendicular to each other. In other words, the alignment direction Df is not tilted with respect to the imaging direction 7d. The imaging portion F3 is tilted at an angle θ1 with respect to the imaging direction 7d. Thus, when the width of the imaging portion F3 in the alignment direction Df is d3, the width of the luminance distribution waveform 25 (e.g., the half width) of the captured image P3 is d3 cos θ1, causing the captured image P3 of the imaging portion F3 to have a width smaller than d3. The imaging portion F3 is thus corrected by dividing the width of the luminance distribution waveform 25 of the captured image P3 by cos θ1 (by multiplying by 1/cos θ1). When the width of the imaging portion F5 in the alignment direction Df is d5, the width of the luminance distribution waveform 25 of the captured image P5 is d5 cos θ2, causing the captured image P5 of the imaging portion F5 to have a width smaller than d5. The imaging portion F5 is thus corrected by dividing the width of the luminance distribution waveform 25 of the captured image P5 by cos θ2 (by multiplying by 1/cos θ2). Note that the imaging portion F4 directly faces the imaging device 7 and thus is not to be corrected. When the distance between the imaging portion F3 and the imaging portion F4 is the same as the distance between the imaging portion F4 and the imaging portion F5, the angle θ1 and an angle θ2 are the same.

In FIG. 23, the alignment direction Df is tilted at an angle φ with respect to the surface perpendicular to the imaging direction 7d. The imaging portion F3 is tilted at an angle θ1 with respect to the imaging direction 7d. Thus, the width of the luminance distribution waveform 25 (e.g., the half width) of the captured image P3 is d3 cos θ1/cos φ, causing the captured image P3 of the imaging portion F3 to have a width larger than d3 cos θ1 and smaller than d3. The position of the imaging portion F3 is changed, by the angle φ, toward the imaging device 7. The imaging portion F3 is thus corrected by multiplying the width of the luminance distribution waveform 25 of the captured image P3 by cos φ/cos θ1. The imaging portion F4 directly facing the imaging device 7 is also affected by the angle φ. When the width of the imaging portion F4 in the alignment direction Df is d4, the width of the luminance distribution waveform 25 of the captured image P4 is d4 cos φ, causing the captured image P4 of the imaging portion F4 to have a width smaller than d4. The imaging portion F4 is thus corrected by multiplying the width of the luminance distribution waveform 25 of the captured image P4 by 1/cos φ. The width of the luminance distribution waveform 25 of the captured image P5 is d5 cos θ2 cos φ, causing the captured image P5 of the imaging portion F5 to have a width smaller than d5 cos θ2. The position of the imaging portion F5 is changed, by the angle φ, away from the imaging device 7. The imaging portion F5 is thus corrected by multiplying the width of the luminance distribution waveform 25 of the captured image P5 by 1/(cos θ2 cos φ).

Although FIGS. 22 and 23 illustrate the correction of the imaging portions F3, F4, and F5 with the alignment direction Df being the lateral direction (horizontal direction), the correction of the imaging portions F1, F3, and F6, or the imaging portions F2, F5, and F7 with the alignment direction Df being the vertical direction may be performed in the same or a similar manner.

The aerial image display device 2 allows operating aerial images with a contactless operation without touching, for example, a button, and may thus be used in, but not limited to, products in various fields as described below. Examples of such products include a communication device for at least one of conversations or communication using aerial images, a medical interview device that allows doctors to interview patients using aerial images, at least one of a navigation device or a driving control device for vehicles such as automobiles, at least one of an order reception or a registration device used in, for example, shops, an operational panel used in, for example, at least one of buildings or elevators, a learning device for teaching or learning classes using aerial images, an office device for at least one of business communication or instructions using aerial images, a gaming device used for playing games using aerial images, a projector for projecting images on at least one of the ground or walls in, for example, at least one of amusement parks or game arcades, a simulation device for simulation using aerial images in, for example, at least one of universities or medical organizations, a large display for displaying prices and other information in, for example, at least one of markets or stock exchanges, and a video viewing device used for viewing aerial videos.

In one or more embodiments of the present disclosure, the optical axis direction of the aerial image can be systematically measured, allowing the optical axis direction of the aerial image to be measured with an automated system. In one or more embodiments of the present disclosure, the optical axis direction of the aerial image can also be calibrated. In one or more embodiments of the present disclosure, the resolution of the aerial image formed by the aerial image display device can also be systematically evaluated.

The structure according to one or more embodiments of the present disclosure may have aspects (1) to (16) described below.

(1) An optical axis direction measurement system, comprising:
an aerial image display device configured to form an aerial image as a real image using image light emitted from at least one image display;
an imaging device configured to capture the aerial image; and
a measurer configured to measure an optical axis direction of the aerial image based on captured images of a plurality of imaging portions in an imaging plane of the aerial image.

(2) The optical axis direction measurement system according to aspect (1), wherein
the measurer is configured to calculate a plurality of characteristic values of luminance distribution waveforms of the captured images of the plurality of imaging portions in the imaging plane of the aerial image and measure the optical axis direction of the aerial image based on the plurality of characteristic values.

(3) The optical axis direction measurement system according to aspect (2), wherein
the measurer is configured to measure, based on the plurality of characteristic values, a tilt angle of the imaging plane with respect to an imaging direction of the imaging device and measure the optical axis direction of the aerial image using the tilt angle.

(4) The optical axis direction measurement system according to aspect (3), further comprising:
a mover configured to move the imaging device in the imaging direction,
wherein the measurer is configured to measure the tilt angle based on changes in the plurality of characteristic values caused by movement of the imaging device.

(5) The optical axis direction measurement system according to aspect (3), further comprising:
a first rotator configured to rotate the imaging device about a rotation axis parallel to a direction perpendicular to a direction in which the plurality of imaging portions is aligned in the imaging plane,
wherein the measurer is configured to measure the tilt angle based on changes in the plurality of characteristic values caused by rotation of the imaging device.

(6) The optical axis direction measurement system according to aspect (2) or aspect (3), further comprising:
a first rotator configured to rotate the imaging device about a rotation axis parallel to a direction perpendicular to a direction in which the plurality of imaging portions is aligned in the imaging plane,
wherein the measurer is configured to calculate, while rotating the imaging device, a plurality of differences between the plurality of characteristic values and determine, as the optical axis direction of the aerial image, an imaging direction of the imaging device when absolute values of the plurality of differences are less than or equal to a first predetermined value.

(7) The optical axis direction measurement system according to aspect (2) or aspect (3), further comprising:
a first rotator configured to rotate the imaging device about a rotation axis parallel to a direction perpendicular to a direction in which the plurality of imaging portions is aligned in the imaging plane,
wherein the measurer is configured to calculate, while rotating the imaging device, the plurality of characteristic values and determine, as the optical axis direction of the aerial image, an imaging direction of the imaging device when all of the plurality of characteristic values are greater than or equal to a second predetermined value.

(8) The optical axis direction measurement system according to any one of aspects (1) to (7), further comprising:
a second rotator configured to rotate the aerial image display device about a rotation axis parallel to a direction perpendicular to a direction in which the plurality of imaging portions is aligned in the imaging plane,
wherein the second rotator is configured to rotate the aerial image display device to cause the optical axis direction of the aerial image measured by the measurer to be parallel to a predetermined optical axis direction of the aerial image display device.

(9) The optical axis direction measurement system according to any one of aspects (1) to (8), wherein
the plurality of imaging portions is at least three imaging portions.

(10) The optical axis direction measurement system according to any one of aspects (1) to (9), wherein
the plurality of imaging portions is a repetition pattern of a first strip image and a second strip image, and
   the first strip image and the second strip image differ from each other in at least one of luminance or color.

(11) An optical axis direction measurement method for measuring an optical axis direction of an aerial image formed by an aerial image display device, the aerial image display device being configured to form the aerial image as a real image using image light emitted from at least one image display, the method comprising:
capturing the aerial image; and
calculating a plurality of characteristic values of luminance distribution waveforms of captured images of a plurality of imaging portions of the aerial image, and measuring the optical axis direction of the aerial image based on the plurality of characteristic values.

(12) A program executable by an optical axis direction measurement system including an aerial image display device configured to form an aerial image as a real image using image light emitted from at least one image display, an imaging device configured to capture the aerial image, and a measurer, the program causing the optical axis direction measurement system to perform operations comprising:
calculating, with the measurer, a plurality of characteristic values of luminance distribution waveforms of captured images of a plurality of imaging portions of the aerial image, and measuring the optical axis direction of the aerial image based on the plurality of characteristic values.

(13) An acceptance determination system, comprising:
the optical axis direction measurement system according to any one of aspects (1) to (10); and
a determiner configured to measure a deviation of the optical axis direction of the aerial image measured by the measurer from a predetermined optical axis direction of the aerial image display device, and determine the aerial image display device to be an acceptable product when the deviation is less than or equal to a third predetermined value.

(14) The acceptance determination system according to aspect (13), wherein
the acceptance determination system is configured to set, when the aerial image display device is determined to be an acceptable product, an aperture value of the imaging device to a value greater than 3 and calculate the modulation transfer functions of the captured images of the plurality imaging portions of the aerial image.

(15) An optical axis direction measurement device, comprising:
an obtainer configured to obtain a plurality of captured images of a plurality of imaging portions in an imaging plane of an aerial image; and
a measurer configured to measure an optical axis direction of the aerial image based on characteristic values of luminance distribution waveforms of the plurality of captured images.

(16) An optical axis direction measurement device, comprising:
an imager configured to capture an aerial image formed as a real image in a space; and
a measurer configured to measure an optical axis direction of the aerial image based on characteristic values of luminance distribution waveforms of a plurality of captured images calculated as resolutions of the plurality of captured images of a plurality of imaging portions in an imaging plane of the aerial image.

Although one or more embodiments of the present disclosure have been described in detail, the present disclosure is not limited to the embodiments described above, and may be changed or varied in various manners without departing from the spirit and scope of the present disclosure. One or more embodiments of the present disclosure include a structure combining two or more of the above embodiments.

### REFERENCE SIGNS

1 optical axis direction measurement system
2 aerial image display device
2a component of aerial image display device
3 image display
4 display panel
4a display surface
5 optical system
5a first optical member
5b second optical member
6 housing
6a image light emitting surface
7 imaging device
7d imaging direction of imaging device
7da predetermined imaging direction of imaging device
8 measurer
9, 9′ test pattern (aerial image)
9a first strip image
9b second strip image
9c, 9d, 9e, 9f square wave chart
10 device mount
10a upper surface
11 mover
11h holder
11r rail
11t movable table
12 first rotator
13 second rotator
14 obtainer
15 determiner
18 measurement device
20 user
20e eye of user
50 acceptance determination system
Da optical axis direction of aerial image
Dad designed optical axis direction
F1 to F7 imaging portion
Lp image light
P1 to P7 captured image
R aerial image
Rp imaging plane

1. An optical axis direction measurement system, comprising:
an aerial image display device configured to form an aerial image as a real image using image light emitted from at least one image display;
an imaging device configured to capture the aerial image; and
a measurer configured to measure an optical axis direction of the aerial image based on captured images of a plurality of imaging portions in an imaging plane of the aerial image.

2. The optical axis direction measurement system according to claim 1, wherein
the measurer is configured to calculate a plurality of characteristic values of luminance distribution waveforms of the captured images of the plurality of imaging portions in the imaging plane of the aerial image and measure the optical axis direction of the aerial image based on the plurality of characteristic values.

3. The optical axis direction measurement system according to claim 2, wherein
the measurer is configured to measure, based on the plurality of characteristic values, a tilt angle of the imaging plane with respect to an imaging direction of the imaging device and measure the optical axis direction of the aerial image using the tilt angle.

4. The optical axis direction measurement system according to claim 3, further comprising:
a mover configured to move the imaging device in the imaging direction,
wherein the measurer is configured to measure the tilt angle based on changes in the plurality of characteristic values caused by movement of the imaging device.

5. The optical axis direction measurement system according to claim 3, further comprising:
a first rotator configured to rotate the imaging device about a rotation axis parallel to a direction perpendicular to a direction in which the plurality of imaging portions is aligned in the imaging plane,
wherein the measurer is configured to measure the tilt angle based on changes in the plurality of characteristic values caused by rotation of the imaging device.

6. The optical axis direction measurement system according to claim 2, further comprising:
a first rotator configured to rotate the imaging device about a rotation axis parallel to a direction perpendicular to a direction in which the plurality of imaging portions is aligned in the imaging plane,
wherein the measurer is configured to calculate, while rotating the imaging device, a plurality of differences between the plurality of characteristic values and determine, as the optical axis direction of the aerial image, an imaging direction of the imaging device when absolute values of the plurality of differences are less than or equal to a first predetermined value.

7. The optical axis direction measurement system according to claim 2, further comprising:
a first rotator configured to rotate the imaging device about a rotation axis parallel to a direction perpendicular to a direction in which the plurality of imaging portions is aligned in the imaging plane,
wherein the measurer is configured to calculate, while rotating the imaging device, the plurality of characteristic values and determine, as the optical axis direction of the aerial image, an imaging direction of the imaging device when all of the plurality of characteristic values are greater than or equal to a second predetermined value.

8. The optical axis direction measurement system according to claim 1, further comprising:
a second rotator configured to rotate the aerial image display device about a rotation axis parallel to a direction perpendicular to a direction in which the plurality of imaging portions is aligned in the imaging plane,
wherein the second rotator is configured to rotate the aerial image display device to cause the optical axis direction of the aerial image measured by the measurer to be parallel to a predetermined optical axis direction of the aerial image display device.

9. The optical axis direction measurement system according to claim 1, wherein
the plurality of imaging portions is at least three imaging portions.

10. The optical axis direction measurement system according to claim 1, wherein
the plurality of imaging portions is a repetition pattern of a first strip image and a second strip image, and
the first strip image and the second strip image differ from each other in at least one of luminance or color.

11. An optical axis direction measurement method for measuring an optical axis direction of an aerial image formed by an aerial image display device, the aerial image display device being configured to form the aerial image as a real image using image light emitted from at least one image display, the method comprising:
capturing the aerial image; and
calculating a plurality of characteristic values of luminance distribution waveforms of captured images of a plurality of imaging portions of the aerial image, and measuring the optical axis direction of the aerial image based on the plurality of characteristic values.

12. A program executable by an optical axis direction measurement system including an aerial image display device configured to form an aerial image as a real image using image light emitted from at least one image display, an imaging device configured to capture the aerial image, and a measurer, the program causing the optical axis direction measurement system to perform operations comprising:
calculating, with the measurer, a plurality of characteristic values of luminance distribution waveforms of captured images of a plurality of imaging portions of the aerial image, and measuring the optical axis direction of the aerial image based on the plurality of characteristic values.

13. An acceptance determination system, comprising:
the optical axis direction measurement system according to claim 1; and
a determiner configured to measure a deviation of the optical axis direction of the aerial image measured by the measurer from a predetermined optical axis direction of the aerial image display device, and determine the aerial image display device to be an acceptable product when the deviation is less than or equal to a third predetermined value.

14. The acceptance determination system according to claim 13, wherein
the acceptance determination system is configured to set, when the aerial image display device is determined to be an acceptable product, an aperture value of the imaging device to a value greater than 3 and calculate the modulation transfer functions of the captured images of the plurality imaging portions of the aerial image.

15. An optical axis direction measurement device, comprising:
an obtainer configured to obtain a plurality of captured images of a plurality of imaging portions in an imaging plane of an aerial image; and
a measurer configured to measure an optical axis direction of the aerial image based on characteristic values of luminance distribution waveforms of the plurality of captured images.

16. An optical axis direction measurement device, comprising:
an imager configured to capture an aerial image formed as a real image in a space; and
a measurer configured to measure an optical axis direction of the aerial image based on characteristic values of luminance distribution waveforms of a plurality of captured images calculated as resolutions of the plurality of captured images of a plurality of imaging portions in an imaging plane of the aerial image.
